(19) United States
(12) Patent Application Publication
(10) Pub. No.: US 2010/0153760 A1
(43) Pub. Date: Jun. 17, 2010

(54) Power Settings in Wireless Ultra-Wide band Universal Serial Bus

(75) Inventors: Vivek Gupta, Bothell, WA (US); Randall E. Aull, Kenmore, WA (US); Pankaj B. Gupta, Bothell, WA (US); Firdosh K. Bhesania, Kirkland, WA (US); Patrick L. Stemen, Redmond, WA (US); Mark E. Maszak, Sammamish, WA (US); David C. Hargrove, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/334,110

(22) Filed: Dec. 12, 2008

(51) Int. Cl. G06F 1/00

(52) U.S. Cl. 713/323; 713/300

(57) ABSTRACT

Various embodiments enable a host controller, through its Protocol Adaption Layer (PAL) driver, to efficiently manage power consumption by employing “sleep mode” and “active mode” power settings. In some embodiments, the PAL driver may employ sleep mode settings to transition the host controller from an idle state to an energy conserving sleep state. In further embodiments, the PAL driver may use active mode settings to govern communications between the host controller and various devices, such as WUSB devices and others, thereby conserving power.

### RELATED APPLICATION

This application is related to an Application bearing attorney docket number 324375.01 entitled “Ultra-Wideband Radio Controller Driver (URCD)-PAL Interface” filed on Dec. 12, 2008, the disclosure of which is incorporated by reference herein.

### BACKGROUND

Ultra-Wideband (UWB) technology enables information to be transmitted over a large bandwidth and can enable high data rate wireless connectivity. UWB technology is described in a set of specifications defined by the WiMedia Alliance (referred to hereinafter as “WiMedia”). In a typical scenario, a host controller wirelessly communicates with one or more devices. A host controller can be embodied on a computing device such as a desktop or laptop computer.

Ultra-Wideband hardware includes a radio controller sub function called the “URC” and one or more sub-functions which run on top of the radio and are considered clients of the radio. Each of the clients is referred to as a Protocol Adaption Layer or “PAL”. Today, PALs exist in the form of Wireless USB PALs, but in the future different bus technologies will inevitably lead to the incorporation of different PALs such as, for example, WUSB PALs, WLP PALs, Bluetooth PALs, vendor-specific PALs and the like.

Individual PALs are utilized to establish connections with associated devices and can share the same UWB radio. As such, hardware and software stacks can be designed to support multiple different types of PALs. One of the challenges associated with enabling wireless connectivity between host controllers and associated devices is to develop two-way interfaces that enable communication between a URC driver (referred to as “URCD”) and PAL drivers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments enable a host controller, through its Protocol Adaption Layer (PAL) driver, to efficiently manage power consumption by employing “sleep mode” and “active mode” power settings. In some embodiments, the PAL driver may employ sleep mode settings to transition the host controller from an idle state to an energy conserving sleep state. In further embodiments, the PAL driver may use active mode settings to govern communications between the host controller and various devices, such as WUSB devices and others, thereby conserving power.

### BRIEF DESCRIPTION OF THE DRAWINGS

The same numbers are used throughout the drawings to reference like features.

FIG. 1 illustrates an operating environment in which the inventive principles can be employed in accordance with one or more embodiments.

FIG. 2 illustrates a system in accordance with one or more embodiments.

FIG. 3 is a flow diagram that describes steps in a method in accordance with one or more embodiments.

FIG. 4 is a flow diagram that describes steps in a method in accordance with one or more embodiments.

FIG. 5 is a flow diagram that describes steps in a method in accordance with one or more embodiments.

FIG. 6 is a flow diagram that describes steps in a method in accordance with one or more embodiments.

FIG. 7 is a table of data transfer parameters in accordance with one or more embodiments.

FIG. 8 is a flow diagram that describes steps in a method in accordance with one or more embodiments.

FIG. 9 illustrates an operating environment in which the inventive principles can be employed in accordance with one or more embodiments.

FIG. 10 is a block diagram of a system in accordance with one or more embodiments.

### DETAILED DESCRIPTION

Overview

Various embodiments provide a two-way interface between a URC radio driver (referred to as the “URCD”) and various Protocol Adaption Layer (PAL) drivers. The two-way interface can enable bandwidth to be shared and managed among multiple different PALs. The two-way interface can also be used to implement common radio functionality such as beaconing, channel selection, and address conflict resolution. In at least some embodiments, the two-way interface can be utilized for power management to place PALs in lower power states to conserve power and to support remote wake-up functionality. Further, at least some embodiments can enable vendor-specific PALs to interact with vendor-specific hardware. In the discussion that follows, Ultra-Wideband technology is utilized to enable different bus technologies to establish a wireless connection with devices and to allow interaction between PAL drivers, the URCD and hardware associated with the PAL drivers.

In the discussion that follows, a section entitled “Operating Environment” describes but one environment in which the various embodiments can be employed. Following this, a section entitled “Example Radio Software” describes a radio software architecture in accordance with one or more embodiments. Next, a section entitled “URCD-PAL Interface—Implementation Example” describes an example interface in accordance with one or more embodiments. Following this, a section entitled “Example Sequence of Operations” describes an example sequence of operations in accordance with one or more embodiments. Next, a section entitled “Example Interface” gives specific examples of an implementation of the URCD-PAL interface. Following this, a section entitled “Power Management” describes an example sequence of power conserving operations in accordance with one or more embodiments. Last, a section entitled “Example System” describes an example system that can implement one or more embodiments.

Operating Environment

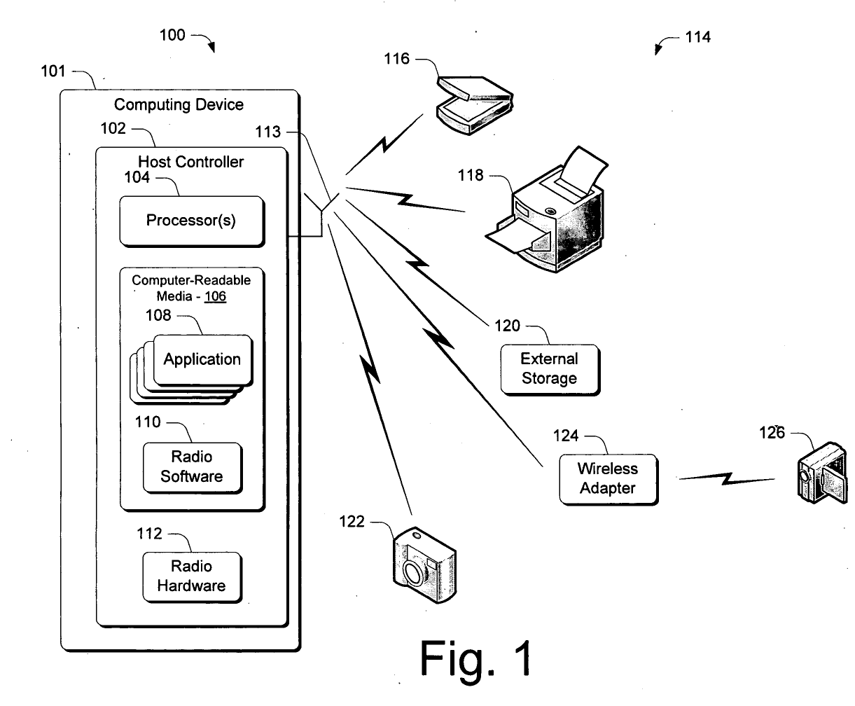

FIG. 1 illustrates an operating environment in accordance with one or more embodiments, generally at 100. Environment 100 includes a computing device 101 embodying a wireless host controller 102. The computing device 101 can take any suitable form examples of which include, by way of example and not limitation, desk top computers, laptop computers and the like. In this particular example, host controller 102 includes one or more processors 104, one or more computer-readable media 106 and, in at least some embodiments, one or more applications 108 that reside on the computer-readable media and which are executable by the processor(s). Applications 108 can include any suitable type of application.

Host controller 102 also includes radio software 110 which interfaces with radio hardware 112 to enable wireless communication with one or more external devices. In the illustrated and described embodiments, the host controller 102 utilizes Ultra-Wideband technology, e.g., any technology whose signals span a frequency range greater than 500 MHz, as a medium to enable wireless communication with the external devices. It is to be appreciated and understood that the various embodiments described herein can be utilized in connection with UWB technology that is compliant with specifications defined by WiMedia, as well as others.

The radio software 110 can include, in one or more embodiments, one or more Protocol Adaption Layers (PALs) and an Ultra-Wideband Radio Controller Driver (URCD). The PAL(s) use an interface with the URCD to manage use of shared resources, e.g. the radio. Host controller 102 includes an antenna 113 via which wireless communication can take place with a number of external devices shown generally at 114.

Devices 114 can include, by way of example and not limitation, a scanner 116, a printer 118, external storage 120, a digital camera 122, a wireless adapter 124 and/or a digital camcorder 126. The external devices interface, in at least some embodiments, with host controller 102 via a Wireless Universal Serial Bus (WUSB) which leverages Ultra-Wideband technology, as will become apparent below. Other means of connecting with the host controller can be used including other bus technologies and transports including, but not limited to PCI, PCIe, cardbus, expresscard and the like.

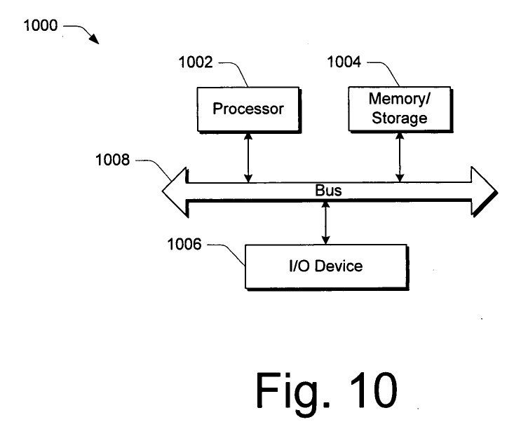

The computer-readable media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 10.

Having considered an example operating environment, consider now a discussion of example radio software in accordance with one or more embodiments.

Example Radio Software

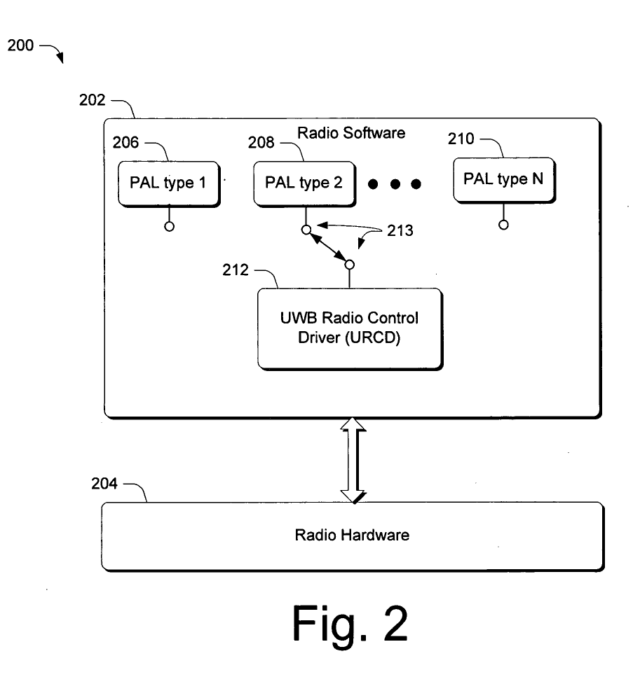

FIG. 2 illustrates a system generally at 200 in accordance with one or more embodiments. In this example, system 200 includes radio software 202 and radio hardware 204. Radio software 202 includes one or more Protocol Adaption Layer (PAL) drivers 206, 208, and 210, also referred to hereinafter as “PALs”. The PALs can comprise any suitable type of PALs. In the illustrated and described embodiment, the PALs are associated with bus technologies such as WUSB, WLP, Bluetooth, and/or vendor-specific bus technologies. In addition, radio software 202 includes a radio control driver (URCD) 212 that serves as one interface between the PALs and radio hardware 204. Radio hardware includes a radio controller referred to in this document as the “URC”. The radio software can run on a computing device, such as the one described above. Alternately or additionally, the radio software can run directly on the radio hardware.

In the illustrated and described embodiment, PALs 206, 208, 210 and URCD 212 communicate by way of a two-way interface or API that is represented using the plug notation generally at 213. An example of a suitable API is described below.

As will be appreciated by the skilled artisan and as noted above, Ultra-Wideband (UWB) can enable different bus technologies (WUSB, WLP, Bluetooth, Vendor Specific, etc) to establish a connection with their associated devices. UWB also has the potential that more than one bus technology can share the same UWB Radio. In this context, URCD 212 is configured to perform a number of different functions including, by way of example and not limitation, beaconing, channel selection, bandwidth allocation, conflict resolution, and address management. In addition, individual PALs are configured to perform a number of different functions including, by way of example and not limitation, requesting bandwidth from the URCD and using bandwidth allocated from the URCD to perform data transfers, set up PAL-specific channels, and the like.

To accomplish these functions, the PALs and the URCD communicate using a two-way interface an example of which is provided below.

FIG. 2 represents a driver architecture for a PCI-connected or a USB-connected UWB Host. In operation, the URCD loads on top of the Physical Device Object (PDO) that is enumerated by the PCI stack or the USB stack. The URCD enumerates children stacks for each PAL functionality present on the host system.

To enable communication between the PALs and the URCD, the URCD creates a Query Interface for which the PAL drivers can query. In one implementation, each PAL driver sends an IRP_MN_QUERY_INTERFACE to exchange an interface between the PAL and the URCD. A Radio Management Layer exposes a table of functions that PALs can call, and PALs expose a table of notification callbacks that the URCD can call. This interface is used by both the PAL and the URCD to communicate with each other.

Having considered example radio software including a driver architecture in accordance with one or more embodiments, consider now a discussion of an example URCD-PAL interface.

URCD-PAL Interface—Implementation Example

In operation, the URCD-PAL Interface utilizes a number of different data structures and data types, examples of which are provided below.

STATUS—This represents the standard NTSTATUS. Custom status codes can be defined here.

PAL_HANDLE—Handle to the PAL. This gets assigned by the URCD to the PAL during initial PAL registration discussed below. PAL uses this handle when calling into URCD.

IE_HANDLE—Handle to an information element that was added by the PAL.

NOTIFICATION_LEVEL—A data type used by some functions described below. This type is defined as an enum:

```
typedef enum {
  URC_Register,
  URC_RegisterForChange,
} NOTIFICATION_LEVEL
```

PAL_Identifier—2 byte value (e.g. a USHORT). This value identifies the PAL's function. PAL fills in this value during registration. The higher order byte is reserved and should be 0. The lower order byte is the URC capability ID.

MAC_CAP_BITMAP—A data type defining the Medium Access Controller (MAC) Capabilities:

| typedef union _MAC_CAP_BITMAP { | |
|---|---|
| // | |
| //The first member of the union is present only | |
| //for making bit operations simpler | |
| // | |
| USHORT | AsUshort; |
| BYTE | Bitmap[2]; |

} MAC_CAP_BITMAP , *PMAC_CAP_BITMAP;

PHY_CAP_BITMAP—A data type defining the physical interface (Phy) Capabilities:

```
  typedef union _PHY_CAP_BITMAP {
    //
    //The first member of the union is present only
    //for making bit operations simpler
    //
    ULONG AsUlong;
    BYTE Bitmap[3];
} PHY_CAP_BITMAP;
```

UWB_BW_INTERVAL: Enum to specify bandwidth (BW) Interval while requesting BW. A “zone” is a set of sixteen temporally consecutive MASes.

```
typedef enum _UWB_BW_INTERVAL {
  UWB_BW_INTERVAL_DONT_CARE = 0,
  UWB_BW_INTERVAL_EVERY_ZONE = 1,
  UWB_BW_INTERVAL_EVERY_2_ZONES = 2,
  UWB_BW_INTERVAL_EVERY_4_ZONES = 4,
  UWB_BW_INTERVAL_EVERY_8_ZONES = 8,
  UWB_BW_INTERVAL_EVERY_16_ZONES = 16,
  UWB_BW_INTERVAL_INVALID
} UWB_BW_INTERVAL;
```

UWB_MAS_MAP—struct used to keep track of MAS Map in a superframe. A “MAS” refers to a Media Access Slot which is a 256 microsecond unit of time.

typedef unsigned short UWB_ZONE_MAP, *PUWB_ZONE_MAP;
typedef struct _UWB_MAS_MAP {
UWB_ZONE_MAP ZoneMap[16];
} UWB_MAS_MAP, *PUWB_MAS_MAP;

CHANNEL_BITMAP—struct used to keep track of supported channels:

| typedef union _CHANNEL_BITMAP { | |
|---|---|
| // | |
| //The first member of the union is present only | |
| //for making bit operations simpler | |
| // | |
| ULONG64 | AsUlong64; |
| BYTE | Bitmap[8]; |

} CHANNEL_BITMAP, *PCHANNEL_BITMAP;

If we call the least significant bit within a byte as Bit0 and the most significant bit as Bit7, then the following is the mapping of bits in the Channel BitMap to actual channel numbers.

| | |
|---|---|
| Bitmap[0] | All bits Unused |
| BitMap[1] | Bit0 to Bit6 represent channels 9 to 15 |
| | in that order. Bit7 is unused. |
| BitMap[2] | Bit0 to Bit6 represent channels 17 to 23 |
| | in that order. Bit7 is unused. |
| BitMap[3] | Bit0 to Bit6 represent channels 25 to 31 |
| | in that order. Bit7 is unused. |
| BitMap[4] | Bit0 to Bit6 represent channels 33 to 39 |
| | in that order. Bit7 is unused. |
| BitMap[5] | Bit0 to Bit4 are unused. Bit 5 and Bit6 |
| | represent channels 45 and 46 respectively. Bit7 |
| | is unused. |
| BitMap[6] | All bits unused |
| BitMap[7] | All bits unused |

If a bit is set, it means the represented channel is supported and if bit is not set, then the channel is not supported.

UWB_BW_REQUEST_STATUS—enum used to maintain the state of a BW Request

| typedef enum _UWB_BW_REQUEST_STATUS { | |
|---|---|
| // | |
| // UWB_BW_ALLOCATED: | |
| // | used when a Critical BW is allocation is |
| | complete |
| // | or when an varying BW allocation is |
| | updated |
| // | |
| UWB_BW_ALLOCATED, | |
| // | |
| // UWB_BW_NEGOTIATING | |
| // | |
| // | |
| UWB_BW_NEGOTIATING, | |
| // | |
| // UWB_BW_FAILED | |
| // | used when a Critical BW allocation fails |
| // | because we are not able to negotiate BW for |
| // | it. |
| UWB_BW_FAILED, | |
| // | |
| // UWB_BW_UNSUPPORTED | |
| // | this type of BW Request is Unsupported. |

```
  //
  UWB_BW_UNSUPPORTED,
  UWB_BW_LOST,
  UWB_BW_RENEGOTATING,
  UWB_BW_CHANGED,
  UWB_BW_PENDING,
} UWB_BW_REQUEST_STATUS;
```

Having described some example data structures and data types, consider first a discussion of a sequence of operations that can be performed by a PAL in accordance with one or more embodiments. Following this discussion, a description of an example interface is provided to illustrate but one way the example sequence of operations can be performed.

Example Sequence of Operations

To begin a sequence of operations, a PAL will typically register with the URC using a particular interface. In the example just below, the PAL registers with the URC by using IRP_MN_QUERY_INTERFACE. Next, a means of communication is established between the PAL and the URCD.

After starting the channel, the following operations can be performed in any order and/or multiple times: allocate and release bandwidth; add/remove IEs; send vendor specific commands; acquire/release TKIDs (“Temporal Key Identifiers” that are used to secure a given packet); get information from URC such as: DevAddress, PhyCapabilityBitMap, MacCapabilityBitMap; set a new channel BitMask; and/or perform a sleep resume cycle.

A cleanup can also be performed for all the commands executed in paragraph [0049]. This can include, by way of example and not limitation, releasing and deleting BW handles and groups; removing added IEs; and/or releasing TKIDs.

The channel can also be stopped when communication is to be terminated and the PAL may or may not unregister with the URC.

It is to be appreciated and understood that the operational steps that begin with starting a channel and continue through those described in the paragraph just above can be repeated any number of times.

Having considered an example sequence of operations in accordance with one or more embodiments, consider now a discussion of an example interface that can be used to implement the above-described sequence of operations as well as other operations.

Example Interface

In this section, a formal definition of a URCD-to-PAL Interface is provided. The URCD-to-PAL Interface is exchanged between the URCD and the PAL by IRP_MN_QUERY_INTERFACE. The guid for this interface is defined by:

```
//
// {CD16C6F8-61CC-4b60-95B7-E91916B0CABD}
//
DEFINE_GUID(GUID_UWB_PAL_INTERFACE,
    0xcd16c6f8,
    0x61cc, 0x4b60,
    0x95, 0xb7, 0xe9, 0x19,
    0x16, 0xb0, 0xca, 0xbd);
```

The type of the interface is UWB_PAL_INTERFACE. It is defined as:

```
typedef struct _UWB_PAL_INTERFACE {
  //
  //Generic header
  //
```

| | |
|---|---|
| INTERFACE | Interface; |

```
  //
  //Information to go from PAL to UWB
  //
```

| | |
|---|---|
| UWB_FROM_PAL_INFO | UwbFromPalInfo; |

```
  //
  //Information to go from UWB to PAL
  //
```

| | |
|---|---|
| UWB_TO_PAL_INFO | UwbToPalInfo; |

```
} UWB_PAL_INTERFACE, *PUWB_PAL_INTERFACE;
//
// The Generic Header
//
typedef struct _INTERFACE {
    USHORT Size;
    USHORT Version;
    PVOID Context; //UNUSED
    PINTERFACE_REFERENCE ;//UNUSED
    PINTERFACE_DEFEFERENCE; //UNUSED
} INTERFACE, *PINTERFACE;
//
//Information to go from PAL to UWB
//
typedef struct _UWB_FROM_PAL_INFO {
  //
  //PAL_Identifier is the same thing as Capability Id
  //
```

| | |
|---|---|
| USHORT | PAL_Identifier; |
| ULONG | Flags; |
| PVOID | PalContext; |

PFN_URCD_DEV_ADDR_CHANGE_NOTIFICATION

AddrChangeNotification;

PFN_URCD_PREPARE_CHANNEL_CHANGE

PrepareChannelChange;

PFN_URCD_CHANNEL_CHANGE_NOTIFICATION

ChannelChangeNotification;

PFN_URCD_VENDOR_SPECIFIC_EVENT_NOTIFICATION

VendorSpecificEventNotification;

PFN_URCD_COMMAND_FRAME_RECEIVED_NOTIFICATION

CommandFrameReceivedNotification;

```
  PFN_URCD_PREPARE_FOR_REMOTE_WAKE_BW_CHANG-
  ES
```

PrepareForRemoteWakeBwChanges;

PFN_URCD_REMOTE_WAKE_BW_CHANGES_COMPLETE

NoMoreRemoteWakeBwChanges;

} UWB_FROM_PAL_INFO, *PUWB_FROM_PAL_INFO;
//
//Information to go from UWB to PAL
//
typedef struct _UWB_TO_PAL_INFO {

| | |
|---|---|
| PAL_HANDLE | PalHandle; |

PFN_URCD_UNREGISTER_PAL

UnregisterPal;

```
  //
  //Querying URC Info
  //
  PFN_URCD_GET_DEV_ADDRESS
```

GetDevAddress;

PFN_URCD_GET_MAC_ADDRESS

GetMacAddress;

PFN_URCD_GET_PHY_CAPABILITY_BITMAP

GetPhyCapabilityBitMap;

PFN_URCD_GET_MAC_CAPABILITY_BITMAP

GetMacCapabilityBitMap;

```
  //
  //Unique TKID generation
  //
  PFN_URCD_ACQUIRE_TKID
```

AcquireTKID;

PFN_URCD_RELEASE_TKID

ReleaseTKID;

```
  //
  //Channel Management
  //
  PFN_URCD_SET_CHANNEL_BIT_MASK
```

SetChannelBitMask;

PFN_URCD_START_CHANNEL

StartChannel;

PFN_URCD_STOP_CHANNEL

StopChannel;

```
  //
  // BandWidth Negotiation
  //
  PFN_URCD_BW_GROUP_CREATE
```

BWGroupCreate;

```
  PFN_URCD_BW_GROUP_RELEASE_AND_DE-
  LETE_ALL_BW
```

BWGroupReleaseAndDeleteAllBw;

PFN_URCD_BW_GROUP_DELETE

BWGroupDelete;

PFN_URCD_BW_GROUP_UPDATE_MAS_AVAILABILITY

BWGroupUpdateMasAvailability;

PFN_URCD_BW_CREATE

BWCreate;

PFN_URCD_CRITICAL_BW_RESERVE

CriticalBWReserve;

PFN_URCD_VARYING_BW_RESERVE

VaryingBWReserve;

PFN_URCD_BW_RELEASE

BWRelease;

PFN_URCD_BW_DELETE

BWDelete;

PFN_URCD_VARYING_BW_INITIATE_AUTO_ADJUST

VaryingBWInitiateAutoAdjust;

PFN_URCD_BW_UPDATE_MAS_AVAILABILITY

BWUpdateMasAvailability;

```
  //
  //IE Management
  //
```

| | |
|---|---|
| PFN_URCD_ADD_IE | AddIE; |
| PFN_URCD_REMOVE_IE | RemoveIE; |

```
  //
  //Vendor Specific Commands/Events
  //
  PFN_URCD_VENDOR_SPECIFIC_COMMAND
```

VendorSpecificCommand;

PFN_URCD_SEND_COMMAND_FRAME

SendCommandFrame;

} UWB_TO_PAL_INFO, *PUWB_TO_PAL_INFO;

The following is an explanation of various fields and functions employed by the Interface in accordance with one or more embodiments.

struct INTERFACE

USHORT Size—Size should be size of the interface.

USHORT Version—Version should be the version of the interface.

PVOID Context—This is unused and should be NULL.

Registration of a PAL

In the illustrated and described embodiment, registration of a PAL happens by the IRP_MN_QUERY_INTERFACE. The PAL fills in the following portions of the URCD_INTERFACE structure and sends it down to the URCD with the IRP_MN_QUERY_INTERFACE Irp.

Interface

UwbFromPalInfo

As part of UwbFromPalInfo, PAL passes a “PalContext” to the URCD. This context is used by URCD whenever calling back into the PAL. The URCD gets the desired information from the URCD_INTERFACE, adds URCD specific information in the following portion and completes the IRP.

UwbToPalInfo

As part of UwbToPalInfo, URCD assigns a PAL_HANDLE to the PAL. The PAL_HANDLE is used by the PAL whenever calling into the URCD to identify itself. This completes the registration process. The following functions are used in relation to registration activities:

UnRegisterPAL

```
VOID
UnregisterPAL(
  PAL_HANDLE PalHandle
  )
```

Arguments:
a. PalHandle is the handle that was assigned by the URCD during registration.

This is a routine to un-register the PAL. Before the PAL un-registers, it ensures that:
All the Bandwidth Objects that it requested have been released and deleted;
It has deleted all the IEs and ASIEs (Application Specific Information Elements) that it had added; and
It has successfully stopped the channel if it had started it.

FIG. 3 is a flow diagram that describes steps in a registration method in accordance with one or more embodiments. The steps can be implemented in connection with any suitable hardware, software, firmware or combination thereof. In at least some embodiments, the method can be implemented in software by, for example, a driver architecture such as the one described above. In the illustrated example, the flow diagram is divided into two portions—one designated “PAL” to depict acts performed by a PAL, and another designated “URCD” to depict acts performed by a URCD.

Step 300 attempts to register with a URCD. The step can be performed in any suitable way an example of which is provided above. Step 302 registers the PAL and step 304 returns a PAL handle to the PAL that just registered.

Step 306 receives the PAL handle. The PAL handle can be used for subsequent calls into the URCD as will become apparent below.

Registration for Notifications

In the illustrated and described embodiment, there are three categories of notification callbacks for which a PAL may register.
1. Notifications to a PAL about a frame (Beacon frame or Command frame) received by the URCD from a device that corresponds to the PAL, and,
2. Notifications to a PAL about URC events such as Device Address Conflict, Start Beacon, Stop Beacon, Channel Change, etc.
3. Notification/Events that have a vendor specific Event Code.

Examples of functions that are utilized in connection with notification registrations include, by way of example and not limitation:

RegisterForBeaconNotifications

| NTSTATUS | | |
|---|---|---|
| RegisterForBeaconNotifications( | | |
| in | PAL_HANDLE | PalHandle, |
| in | NOTIFICATION_LEVEL | NotificationLevel, |
| in | PFN_URCD_BEACON_NOTIFICATION | |
| | | BeaconNotification, |
| in _opt | PVOID | Context |
| ) | | |

This function allows a PAL to register for beacon notifications/beacon change notifications from its all devices or a particular device.

### Arguments:

a. Pal: The handle that the PAL received when the PAL registered with the URCD.
b. NotificationLevel: An enum with the following definition. For context, reference to the NOTIFICATION_INFO data type can be made:
   i. URC_Register=Register for Beacon Notifications. This means that the notification callback is called whenever a beacon is received.
   ii. URC_RegisterForChange=Register for Beacon Changed Notification. This means that the notification callback is called whenever the received beacon has changed. This can be based on a hashing function and thus may rarely miss a beacon change notification.
c. BeaconNotification: Callback function to be implemented by PAL. URCD will use this function to send beacon notifications to the PAL. The prototype is: VOID.

| | | |
|---|---|---|
| BeaconNotification( | | |
| in_opt | PVOID | Context, |
| in | ULONG | Length, |
| in | PBYTE | BeaconData |
| ) | | |

Context: Context that was passed during RegisterForBeaconNotifications
Length: Length of the beacon
BeaconData: Beacon Data

### Return Value:

Returns an NT_SUCCESS( ) value if Register call is successful; otherwise an appropriate error is returned.

UnregisterForBeaconNotifications

```
VOID UnregisterForBeaconNotifications(
      in PAL_HANDLE  Pal
    )
```

This function allows a PAL to unregister for beacon received notifications/beacon change notifications from all its devices or a particular device.

### Arguments:

a. Pal: The handle to the PAL received when the PAL registered with the URCD.

### Return Value:

NONE

RegisterForIENotifications

NTSTATUS
RegisterForIENotifications(

| in | PAL_HANDLE | PalHandle, |
|---|---|---|
| in | BYTE | IESpecifierID, |
| in | NOTIFICATION_LEVEL | NotificationLevel, |
| in | PFN_URCD_IE_NOTIFICATION | |
| | | IENotification, |
| in _opt | PVOID | Context |
| ) | | |
| AND | | |

RegisterForASIENotifications

NTSTATUS
RegisterForASIENotifications(

| in | PAL_HANDLE | PalHandle, |
|---|---|---|
| in | BYTE | ASIESpecifierID, |
| in | NOTIFICATION_LEVEL | NotificationLevel, |
| in | PFN_URCD_ASIE_NOTIFICATION | |
| | | ASIENotification, |
| in _opt | PVOID | Context |
| ) | | |

This function allows a PAL to register for IE or ASIE received notifications/change notifications from its all devices or a particular device.

### Arguments:

a. Pal: The handle to the PAL received when the PAL registered with the URCD.
b. ASIESpecifierID: ULONG representing ASIE Specifier IDs. OR
IESpecifierID: BYTE representing IE Specifier IDs.
c. NotificationLevel: An Enum using the following definition. Reference can be made to the NOTIFICATION_INFO data type:
   i. URC_Register=Register for IE or ASIE Notifications. This means that the notification callback is called whenever the IE or ASIE is received.
   ii. URC_RegisterForChange=Register for IE or ASIE Changed Notification. This means that the notification callback is called whenever the received IE or ASIE has changed. This may be based on a hashing function and thus it is possible to rarely miss an IE or ASIE change notification.
   d. ASIENotification: A notification callback of the prototype VOID.

| ASIENotification( | | |
|---|---|---|
| in | PVOID | Context, |
| in | ULONG | ASIELength, |
| in | PBYTE | ASIEData |
| ) | | |
| OR | | |
| IENotification: A notification callback of the prototype | | |
| VOID | | |
| IENotification( | | |
| in | PVOID | Context, |
| in | ULONG | IELength, |
| in | PBYTE | IEData |
| ) | | |

### Return Value:

Returns an NT_SUCCESS( ) value if Register call is successful; otherwise an appropriate error is returned.

UnregisterForASIENotifications

| VOID UnregisterForASIENotifications( | | |
|---|---|---|
| in | PAL_HANDLE | Pal, |
| in | ULONG | ASIESpecifierID |
| ) | | |
| AND | | |

UnregisterForIENotifications

| VOID UnregisterForIENotifications_( | | |
|---|---|---|
| in | PAL_HANDLE | Pal, |
| in | ULONG | IESpecifierID |
| ) | | |

These functions allow a PAL to unregister for IE or ASIE notifications/IE or ASIE change notifications from its all or particular devices.

### Arguments:

a. Pal: The handle to the PAL received when the PAL registered with the URCD.
b. ASIESpecifierID: ULONG representing ASIE Specifier IDs. OR
IESpecifierID: BYTE representing IE Specifier IDs.

### Return Value:

NONE

In one or more embodiments, a PAL may register for some other notification callbacks with the URCD. It does this by implementing the following notification callbacks. These notification callbacks are sent to the URCD when the PAL registers with the URCD using the IRP_MN_QUERY_INTERFACE.

AddrChangeNotification

| | |
|---|---|
| VOID | |
| AddrChangeNotification ( | |
| in PVOID | PalContext, |
| in DEVADDR | Address |
| ); | |

This function is used whenever the URCD sets a new 16 bit device address, it will call using this function to notify the PAL about it.

### Arguments:

a. PalContext: Context that was passed by the PAL during registration (in the UwbFromPalInfo structure).
b. Address: The new 16 bit dev address

PrepareChannelChange

| | |
|---|---|
| VOID | |
| PrepareChannelChange ( | |
| in PVOID | PalContext, |
| in UCHAR | Channel, |
| in UCHAR | ChangeCountDown, |

in PFN_URCD_PREPARE_CHANNEL_CHANGE_COMPLETION

| | |
|---|---|
| | PrepareChannelChangeCompletion |
| ); | |

This function is used whenever the URCD is about to change a channel. It first calls the PAL to let it know about the change and to give the PAL a chance to let its devices know about the change. When the PAL is done processing this notification, it calls the PrepareChannelChangeCompletion function that was passed in this function by the URCD.

### Arguments:

a. PalContext: Context that was passed by PAL during registration (in the UwbFromPalInfo structure).
b. Channel: The target channel that URCD is going to shift to.
c. ChangeCountDown: The number of superframes after which URCD is going to change the channel.
d. PrepareChannelCompletionRoutine: Pal calls this function after it is done processing the change channel request. The prototype is VOID

```
PrepareChannelChangeCompletion(
    in  PAL_HANDLE  PalHandle
  )
```

ChannelChangeNotification

| | |
|---|---|
| VOID | |
| ChannelChangeNotification( | |
| in PVOID | PalContext, |
| in UCHAR | Channel |
| ); | |

This function is used by URCD to notify PAL about a channel change operation.

### Arguments:

a. PalContext: Context that was passed by PAL during registration (in the UwbFromPalInfo structure).
b. Channel: The new channel being used by URCD

VendorSpecificEventNotification

| VOID | |
|---|---|
| VendorSpecificEventNotification ( | |
| in PVOID | PalContext, |
| in PVOID | Rceeb |
| ); | |

This function is used by URCD to notify PAL about a vendor specific event received from the hardware. URCD just acts a pass through in this case and it is up to the PAL to decode the event.

### Arguments:

a. PalContext: Context that was passed by PAL during registration (in the UwbFromPalInfo structure).
b. Rceeb: The new RCEEB (Radio Controller Extended Event Block) received by the hardware. The size information is contained within the RCEEB—so no separate parameter is used.

CommandFrameReceivedNotification

| VOID | |
|---|---|
| CommandFrameReceivedNotification ( | |
| in PVOID | PalContext, |
| in ULONG | RcebSize, |
| in PVOID | Rceb |
| ); | |

This function is used by URCD to notify PAL about a command frame received over the air.

### Arguments:

a. PalContext: Context that was passed by PAL during registration (in the UwbFromPalInfo structure).
b. RcebSize—Size of the RCEB (Radio Controller Event Block) received by the hardware
c. Rceb—RCEB received by the hardware.

PrepareForRemoteWakeBwChanges

VOID
PrepareForRemoteWakeBwChanges (

| | |
|---|---|
| in PVOID | PalContext, |

in PFN_URCD_PREPARE_REMOTE_WAKE_BW_CHANGES_COMPLETION

PrepareRemoteWakeBwChangesCompletion

);

This function is used whenever the URCD is about to send allocation changes for its remote wake bandwidth. It first calls the PAL to let it know about the allocation change and give it a chance to prepare. If the PAL is sleeping, it might need to wake up its hardware. When PAL is done processing this notification, it calls the completion function that was passed by URCD:

### PrepareRemoteWakeBwChangesCompletion.

### Arguments:

a. PalContext: Context that was passed by PAL during registration (in the UwbFromPalInfo structure).
b. PrepareRemoteWakeBwChangesCompletion: Pal calls this function after it is ready to receive Remote Wake Bw Changes. The prototype is VOID

```
PrepareRemoteWakeBwChangesCompletion(
      in  PAL_HANDLE  PalHandle
    )
```

NoMoreRemoteWakeBwChanges

VOID
NoMoreRemoteWakeBwChanges (

| | |
|---|---|
| in PVOID | PalContext, |

in PFN_URCD_NO_MORE_REMOTE_WAKE_BW_CHANGES_COMPLETION

NoMoreRemoteWakeBwChangesCompletion

);

This function is used whenever the URCD is about to send allocation changes for its remote wake bandwidth, it first calls in the PAL to let it know about the allocation change and give it a chance to prepare through PrepareForRemoteWakeBwChanges. When URCD is done sending all the notifications for changes in remote wake bandwidth, it calls NoMoreRemoteWakeBwChanges. If the PAL woke itself up for these changes, it might need to go back to sleep. When PAL is done processing this notification, it calls the completion function, NoMoreRemoteWakeBwChangesCompletion.

### Arguments:

a. PalContext: Context that was passed by PAL during registration (in the UwbFromPalInfo structure).
b. NoMoreRemoteWakeBwChangesCompletion: Pal calls this function after it has done processing the notification. The prototype is VOID

```
NoMoreRemoteWakeBwChangesCompletion(
      in PAL_HANDLE  PalHandle
    )
```

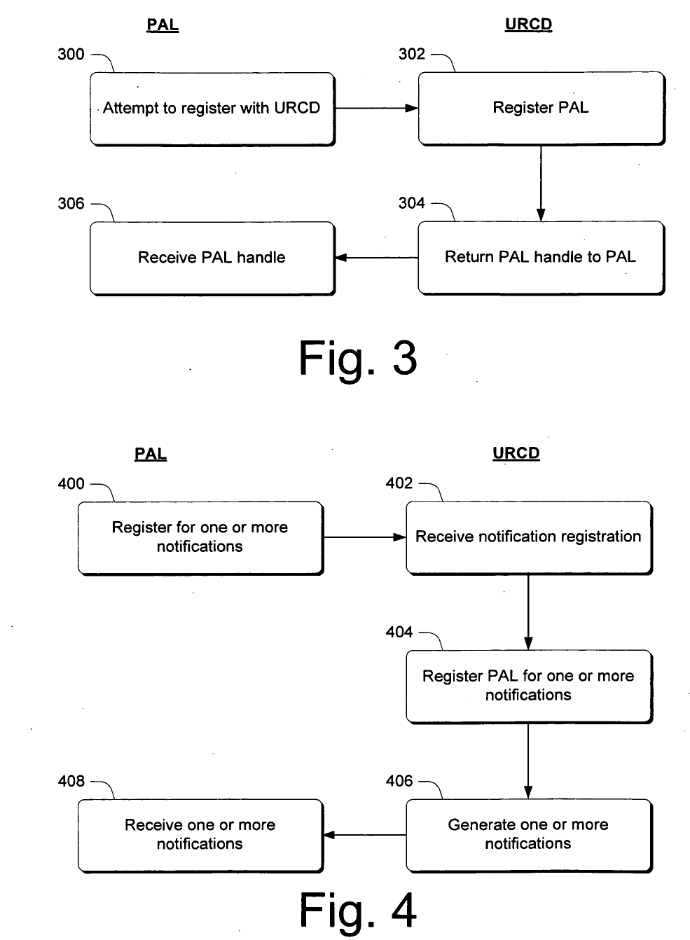

FIG. 4 is a flow diagram that describes steps in a notification registration method in accordance with one or more embodiments. The steps can be implemented in connection with any suitable hardware, software, firmware or combination thereof. In at least some embodiments, the method can be implemented in software by, for example, a driver architecture such as the one described above. In the illustrated example, the flow diagram is divided into two portions—one designated “PAL” to depict acts performed by a PAL, and another designated “URCD” to depict acts performed by a URCD.

Step 400 registers for one or more notifications. Examples of how a PAL can register for a notification and various types of notifications are described above. Step 402 receives a notification registration from the PAL and step 404 registers the PAL for one or more notifications. In an event a registered-for notification is generated, step 406 generates one or more notifications and sends the notifications to the PAL that registered for the notification(s).

Step 408 receives the one or more notifications from the URCD.

Adding IE & ASIE

In one or more embodiments, a PAL may request the URCD to add certain IEs and ASIEs to the HOST Beacon. In connection with these activities, the following functions can be used:

AddIE

| VOID | | |
|---|---|---|
| AddIE( | | |
| in | PAL_HANDLE | PalHandle, |
| in | USHORT | Length, |
| in | BYTE* | IEBuffer, |
| in | PFN_URCD_ADD_IE_COMPLETION | |
| | | CompletionCallback, |
| in_opt | PVOID | Context |
| ); | | |

This function allows the PAL to add ASIEs and/or certain other types of IEs.

### Arguments:

a. Pal: The handle to the PAL received when the PAL registered with the URCD.
b. Length: Length of IE_Buffer in Bytes.
c. IE Buffer: A buffer containing an IE or an ASIE.
d. AddIECompletionCallback: URCD will call this function when either the IE has been successfully added to the hardware or if there is a failure.

The prototype for the callback is:

| typedef | | |
|---|---|---|
| VOID | | |
| AddIECompletionCallback( | | |
| in | NTSTATUS | Status, |
| in | URC_IE_HANDLE | IEHandle, |
| in_opt | PVOID | Context |
| ) | | |

Status: is the result of trying to add the given IE

Context: is the context which was passed in the AddIE function.

IEHandle: is the handle to the IE that should be preserved by the PAL to be used later while removing the IE
e. Context: The context that will be passed back in the CompletionCallback

### Return Value:

VOID

RemoveIE

| VOID | | |
|---|---|---|
| RemoveIE( | | |
| in | PAL_HANDLE | PalHandle, |
| in | URC_IE_HANDLE | IEHandle, |
| in | PFN_URCD_REMOVE_IE_COMPLETION | |
| | | Completion, |
| in_opt | PVOID | Context |
| ) | | |

This function allows the PAL to remove IEs and ASIEs from the URCs beacon. The PAL can remove the IEs it added with the AddIEs API call.

### Arguments:

a. Pal: The handle to the PAL received when the PAL registered with the URCD.
b. IEHandle: Handle that was given to the PAL during AddIECompletionCallback.
c. RemoveIECompletionCallback: URCD will call this function when the IE has been successfully deleted

The prototype for the callback is:

```
typedef
VOID
RemoveIECompletionCallback(
      in_opt  PVOID  Context
    )
```

Context: is the context which was passed in the RemoveIE function.
d. Context: The context that will be passed back in the CompletionCallback

### Return Value:

NONE.

RemoveAllIEs(PAL_HANDLE Pal)

This function allows the PAL remove all IEs and ASIEs that it had added with the AddIEs API call.

### Arguments:

a. Pal: The handle to the PAL received when the PAL registered with the URCD.

### Return Value:

NONE.

In one or more embodiments, there can be a callback that the PAL provides that can tell the client that all the IE data it had notified about has been deleted. This would be helpful in a recovery situation in case an unexpected error happens in the URCDs IE module. Alternately or additionally, there can be a callback that the PAL provides that could be a reset callback that would mean that the URCD has reset itself and now contains no PAL specific information. In this case, the PALs would re-register and restart their work.

Bandwidth Negotiation

In one or more embodiments, individual PALs utilize bandwidth for transferring data and bandwidth allocations are divided into two classes: Critical BW and Varying BW. Critical BW refers to reservations that a PAL needs to function well. Varying BW, on the other hand, refers to reservations in addition to Critical reservations that the PAL can use for improving its data transfers.

In one or more embodiments, before the PAL can request BW from the URCD, it creates a Bandwidth Group that defines the (Owner, Target, StreamIndex, ReservationType). After it has created the Bandwidth Group, the PAL can create Bandwidth that is associated with a BW Group.

In connection with bandwidth negotiation activities, the following functions can be used:

BWGroupCreate

| NTSTATUS | | |
|---|---|---|
| BWGroupCreate( | | |
| in | PAL_HANDLE | PalHandle, |
| in | DEVADDR | TargetDeviceAddress, |
| in | BYTE | StreamIndex, |
| in | BYTE | ReservationType, |
| in_opt | PUWB_MAS_MAP | DeviceAvailability, |
| in | ULONG | Flags, |
| in_opt | PFN_URCD_CALLBACK_BW_GROUP_ALLOCATION_CHANGE | |
| | | CallbackOnChange, |
| in_opt | PVOID | ChangeContext, |

| | |
|---|---|
| out | BW_GROUP_HANDLE *BWGroupHandle |
| ); | |

This function can be used if a PAL needs bandwidth from the URCD. The PAL first creates a bandwidth group. A bandwidth group defines the (Target Device Address, Stream Index, and Reservation Type). Once a bandwidth group has been created, the PAL may create and reserve several bandwidth components to get the required bandwidth.

### Arguments:

a. PalHandle: The handle to the PAL received when the PAL registered with the URCD.
b. TargetDeviceAddress: The target device address
c. Stream Index: Stream Index
d. Reservation Type: The reservation type needed (as per defined by the DRP IE in MAC Spec). Reservation Type cannot be 0 i.e. Type Alien BP.
e. DeviceAvailabilityMap: A bitmap informing the URCD about the device availability information. The URCD will cache this information, and the PAL tells the URCD of any updates to this information. The URCD provides this information if and only if it sets the FLAG_URCD_DEVICEAVAILABILITY_INFO_BY_PAL flag
f. Flags:
   i. Bit 0: It is a MultiCast Reservation (FLAG_URCD_MULTICAST)
   ii. Bit 1: PAL will provide DeviceAvailabilityInfo
   iii. Bit 2: PAL will provide DeviceAvailabilityInfo for each Reservation Request.
   iv. Rest bits are reserved for future use.
      RULES: If bit 0 is set bit 1 or 2 must be set.
         Both bit1 and bit2 must not be set.
g. CallbackOnChange: (Optional) If provided by the PAL, the URCD would call it to notify the PAL about any changes in the cumulative Mas slots allocated for all the reservations under this Bw Group.

The prototype is

VOID
CallbackOnChange (

| | | |
|---|---|---|
| in | PVOID | ChangeContext, |
| in | PUWB_MAS_MAP | AllocatedMases, |

| | |
|---|---|
| in | UWB_BW_REQUEST_STATUS |

BwStatus,

| | |
|---|---|
| in | PFN_URCD_BW_GROUP_ALLOCATION_CHANGE_COMPLETE |

ChangeComplete

);
ChangeContext - The ChangeContext that was passed in
the BWGroupCreate Function.
AllocatedMases - A bitmap of the current MASes
allocated for this request
BwStatus - Reason for calling this notification
callback.
ChangeComplete - A function that the PAL must call
back once is has successfully completed updating its
mases. The Protoype is:
VOID
ChangeComplete(

| | | |
|---|---|---|
| in | BW_GROUP_HANDLE | BWGroupHandle, |
| in | NTSTATUS | Status |
| ); | | |

h. ChangeContext:(Optional) An context that is passed in the above CallbackOnChange callback.
i. BwGroupHandle: Output: Handle to the BW Group.

### Return Value:

STATUS—STATUS_INSUFFICIENT_RESOURCES if there is a low memory situation.

BWGroupReleaseandDeleteAllBw

VOID
BWGroupReleaseandDeleteAllBw (

| in | BW_GROUP_HANDLE | BWGroupHandle, |
|---|---|---|
| in | PFN_URCD_BW_GROUP_CALLBACK_RELEASE_AND_DELETE_ALL | |
| | | CompletionOnReleaseAndDeleteAll, |
| in_opt | PVOID | ReleaseAndDeleteAllContext |
| ); | | |

This request tells the URCD to release and delete any Bandwidth components of this BW Group. In one or more embodiments, the PAL treats the BW_HANDLEs that are associated with the BW Group as destroyed as soon as this function is called and PAL may not use any such BW_HANDLE after issuing this call.

### Arguments:

a. BWGroupHandle: The Handle of BW Group received on a call to BWGroupCreate
b. CallbackOnReleaseAndDeleteAll: A callback provided by the PAL that the URCD calls when all the Bw components are released and deleted.

The prototype of the callback is

```
typedef
VOID
CallbackOnReleaseAndDeleteAll(
      in  PVOID  ReleaseAndDeleteContext
    );
ReleaseAndDeleteContext - The Context that is passed
in the BWGroupReleaseAndDeleteAllBw function.
```

c. ReleaseAndDeleteContext: (optional) An optional context that for the CallbackOnReleaseAndDeleteAll callback described above

### Return Value:

NONE

BWGroupDelete

```
VOID
BWGroupDelete(
      in  BW_GROUP_HANDLE BWGroupHandle
    );
```

This request tells the URCD to delete the BW Header that was created during the BWGroupCreate call. It is to be noted that if the PAL has some BW that was reserved for the BW Group, the PAL first releases and deletes each of those BW requests, OR, the PAL calls BWGroupReleaseAndDeleteAllBw and waits for that request to complete before making a call to BWGroupDelete.

The PAL treats the BW_GROUP_HANDLE as destroyed as soon as this function is called and PAL may not use BW_GROUP_HANDLE after issuing this call.

### Arguments:

a. BWGroupHandle: The Handle of BW Group received on a call to BWGroupCreate

### Return Value:

NONE

BwGroupUpdateMasAvailability

| VOID | | |
|---|---|---|
| BwGroupUpdateMasAvailability( | | |
| in | BW_GROUP_HANDLE | BWGroupHandle, |
| in | PUWB_MAS_MAP | MasAvailability |
| ); | | |

If the PAL provided a DeviceAvailability during the BWGroupCreate Call, it can update that Availability Info by calling this function.

### Arguments:

a. BwGroupHandle: The Handle of BW Group received on a call to SetupReservationHeader
b. MasAvailability: A bitmap informing the URCD about the updated device availability information. The URCD will cache this information.

### Return Value:

NONE

BWCreate

| | | |
|---|---|---|
| NTSTATUS | | |
| BWCreate ( | | |
| in | BW_GROUP_HANDLE | BWGroupHandle, |
| out | BW_HANDLE | *BWHandle |
| ); | | |

This routine allows the PAL to create a BW Component for a BW Group it had created earlier.

### Arguments:

a. BWGroupHandle: The handle to the BWGroup that was received on the call to BWGroupCreate.
b. BwHandle: Output: Handle to the BW Component.

### Return Value:

STATUS—STATUS_INSUFFICIENT_RESOURCES if we are in low memory situation.

CriticalBWReserve

typedef
NTSTATUS
CriticalBWReserve (

| in | BW_HANDLE | BWHandle, |
|---|---|---|
| in | UWB_BW_INTERVAL | Interval, |
| in | USHORT | Time, |
| in_opt | PUWB_MAS_MAP | DeviceAvailability, |
| in | ULONG | Flags, |
| in | PFN_URCD_CALLBACK_BW_RESERVE | |
| | | CallbackOnReserve, |
| in_opt | PVOID | ReserveContext, |
| in_opt | PFN_URCD_CALLBACK_BW_ALLOCATION_CHANGE | |
| | | CallbackOnChange, |
| in_opt | PVOID | ChangeContext |
| ); | | |

After the PAL has create a BW Handle, the PAL uses this routine to request Critical BW.

### Arguments:

a. BwHandle: The Handle of BW received on a call to BWCreate
b. Interval: The Periodicity of the needed BW.
c. Time: Number of micro-seconds needed per Zone.
   Valid Values are: 1 to 256 OR in multiples of 256.
d. MasAvailabilityMap: A bitmap informing the URCD about the MAS availability information. The URCD would allocation bw only out of this availability information. The URCD will cache this information, and the PAL then tells the URCD of any updates to this information. The URCD provides this information if and only if it set the Flags bit when it called the BwGroupCreate
e. Flags: Reserved for future.
f. CallbackOnReserve: The URCD would call it to notify the PAL whether it was able to reserve the Critical BW for the PAL. The prototype is

| VOID | | |
|---|---|---|
| CallbackOnReserve( | | |
| in_opt | PVOID | ReserveContext, |
| in | BOOLEAN | Success |

);
ReserveContext - The context that is passed in the
CriticalBWReserve function
Success - If TRUE means that bandwidth was reserved
successfully. Else it means that the bandwidth could
not be reserved.
Note:
If Success is TRUE, the CallbackOnChange would be called to notify the PAL about what Mases were allocated.

g. ReserveContext: (Optional) Context to be passed in CallbackOnReserve callback.
h. CallbackOnChange: (Optional) If provided by the PAL, the URCD would call it to notify the PAL about any changes in the Mas slots allocated.

The prototype is

VOID
CallbackOnChange(

| | | |
|---|---|---|
| in_opt | PVOID | ChangeContext, |
| in | PUWB_MAS_MAP | AllocatedMases, |

| | |
|---|---|
| in | UWB_BW_REQUEST_STATUS |

BwStatus,

| | |
|---|---|
| in | PFN_URCD_BW_ALLOCATION_CHANGE_COMPLETE |

ChangeComplete

);
ChangeContext - The ChangeContext that was passed in
the CriticalBWReserve Function.
AllocatedMases - A bitmap of the current MASes
allocated for this request
BwStatus - Reason for calling this notification
callback.
ChangeComplete - A function that the PAL calls back
once it has successfully completed updating its
mases. The Protoype is:
VOID
ChangeComplete(

| | | |
|---|---|---|
| in | BW_HANDLE | BWHandle, |
| in | NTSTATUS | Status |

);

i. ChangeContext: The context that is passed in the CallbackOnChange callback.

### Return Value:

STATUS—STATUS_INSUFFICIFNT_RESOURCES if we are in low memory situation.

VaringBWReserve

typedef
NTSTATUS
VaryingBWReserve (

| in | BW_HANDLE | BWHandle, |
|---|---|---|
| in | UWB_BW_INTERVAL | Interval, |
| in | USHORT | Time, |
| in_opt | PUWB_MAS_MAP | DeviceAvailability, |
| in | ULONG | Flags, |
| in_opt | PFN_URCD_CALLBACK_BW_ALLOCATION_CHANGE | |
| | | CallbackOnChange, |
| in_opt | PVOID | ChangeContext, |
| in | PULONG | ByteTransferCounter |
| ); | | |

After the PAL has setup a BW Header, the PAL uses this routine to request a Varying BW.

### Arguments:

a. BwHandle: The Handle of BW received on a call to BWCreate
b. Interval: (Optional meant as a Suggestion to URCD) The Periodicity of the needed BW. Set to UWB_BW_INTERVAL_DONT_CARE if the PAL does not care.
c. Time: (Optional meant as a Suggestion to the URCD) Number of micro-seconds needed per Zone. (Set to 0 if PAL does not care)
   Valid Values are: 0, OR multiples of 256.
d. MasAvailabilityMap: A bitmap informing the URCD about the MAS availability information. The URCD would allocation BW only out of this availability information. The URCD will cache this information, and the PAL tells the URCD of any updates to this information. The URCD provides this information if and only if it set the Flags bit in when it called the BwGroup Create
e. Flags: Reserved for future.
f. CallbackOnChange: (Optional) If provided by the PAL, the URCD would call it to notify the PAL about any changes in the Mas slots allocated.

The prototype is

VOID
CallbackOnChange(

| | | |
|---|---|---|
| in_opt | PVOID | ChangeContext, |
| in | PUWB_MAS_MAP | AllocatedMases, |

| | |
|---|---|
| in | UWB_BW_REQUEST_STATUS |

BwStatus,

| | |
|---|---|
| in | PFN_URCD_BW_ALLOCATION_CHANGE_COMPLETE |

ChangeComplete

);
ChangeContext - The ChangeContext that was passed in
the VaryingBWReserve Function.
AllocatedMases - A bitmap of the current MASes
allocated for this request
BwStatus - Reason for calling this notification
callback.
VOID
ChangeComplete(

| | | |
|---|---|---|
| in | BW_HANDLE | BWHandle, |
| in | NTSTATUS | Status |
| ); | | |

g. ChangeContext: The context that is passed in the CallbackOnChange callback.
h. BytesTransferredCounter: A pointer to a counter that keeps track of the number of bytes transferred. The PAL keeps this counter updated. URCD will look at the contents of this counter to adjust bandwidth for this request.

### Return Value:

STATUS—STATUS_INSUFFICIENT_RESOURCES if we are in low memory situation.

BWRelease

| VOID | | |
|---|---|---|
| BWRelease( | | |
| in | BW_HANDLE | BWHandle, |
| in | PFN_URCD_CALLBACK_BW_RELEASE | |
| | | CallbackOnRelease, |
| in_opt | PVOID | ReleaseContext |
| ); | | |

This request tells the URCD to release the BW reservation.

### Arguments:

a. BWHandle: The Handle of BW Group received on a call to BWCreate
b. CallbackOnRelease: A callback provided by the PAL that the URCD calls when the BW is released

| VOID | | |
|---|---|---|
| CallbackOnRelease( | | |
| in_opt | PVOID | ReleaseContext |

);
ReleaseContext - The ReleaseContext that was passed
in the BWRelease function.

c. ReleaseContext: A context that is passed in when the CallbackOnRelease callback is called.

### Note:

After the CallbackOnRelease has been called, the PAL may reuse the BW_HANDLE to send a new BwReserve request to the URCD.

### Return Value:

NONE

BWDelete

| VOID | | |
|---|---|---|
| BWDelete( | | |
| in | BW_HANDLE | BWHandle |
| ); | | |

This request tells the URCD to delete the BW that was created during the BWCreate. It should be noted that if this BW_HANDLE was used in a call to CriticalBWReserve or VaryingBWReserve call, the PAL first releases that BW by calling the BWRelease function. Further, the PAL treats that BW_HANDLE as destroyed as soon as this function is called and the PAL may not use BW_HANDLE after issuing this call.

### Arguments:

a. BWHandle: The Handle of BW received on a call to BWCreate

### Return Value:

NONE

VOID VaryingBWInitiateAutoAdjust(

typedef
VOID
(*PFN_URCD_VARYING_BW_INITIATE_AUTO_ADJUST) (

| | | |
|---|---|---|
| in | BW_HANDLE | BWHandle, |
| in | ULONG | Time |
| ); | | |

This request tells the URCD to start adjusting the Varying BW.

### Arguments:

a. BWHandle: The Handle of BW received on a call to BWCreate
b. Time: Reserved

### Return Value:

NONE

BWUpdateMasAvailability

| VOID | | |
|---|---|---|
| BWUpdateMasAvailability ( | | |
| in | BW_HANDLE | BWHandle, |
| in | PUWB_MAS_MAP | MasAvailability |
| ); | | |

If the PAL provided AvailabilityInfo during Allocate BW Call, it can update that Availability Info by calling this function.

### Arguments:

a. BwHandle: The Handle of BW request
b. DeviceAvailabilityMap: A bitmap informing the URCD about the updated device availability information. The URCD will cache this information.

### Return Value:

NONE

Consider now some implementation considerations concerning bandwidth negotiation in accordance with one or more embodiments. In one or more embodiments, to be able to reserve any BW, the user should have: a BW group (created earlier by BWGroupCreate) and a BW component (created earlier by BWCreate). In the above-described embodiment, two types of BW can be reserved: Critical and Varying (CriticalBWReserve, VaryingBWReserve). Further, multiple BW components can belong to the same group. In addition, in at least some embodiments, Reserve may be called only once for each BW component, unless the previous Reserve was released (BWRelease) or Reserve failed (in case of critical). For example, a BW component may be used again to reserve another BW, once it has been released. Further, if the BW was reserved, in at least some embodiments, it must be released before it can be deleted. In addition, in at least some embodiments, Release BW for critical BW should only be called if the reserve completion routine returned success. Lastly, in at least some embodiments, all BW handles (belonging to a BW group) must be deleted before that BW group can be deleted.

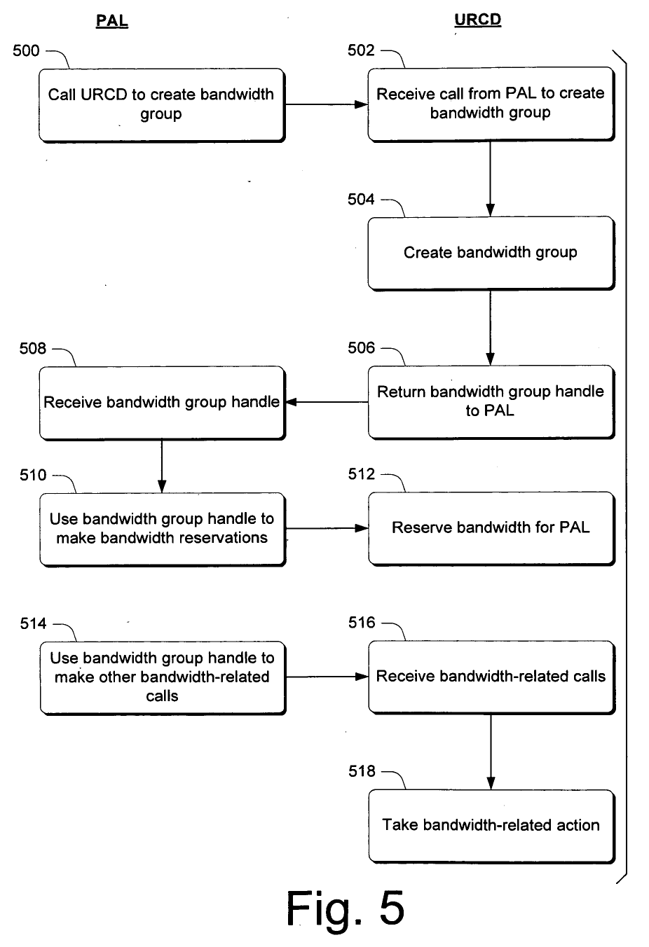

FIG. 5 is a flow diagram that describes steps in a process for handling bandwidth in accordance with one or more embodiments. The steps can be implemented in connection with any suitable hardware, software, firmware or combination thereof. In at least some embodiments, the method can be implemented in software by, for example, a driver architecture such as the one described above. In the illustrated example, the flow diagram is divided into two portions—one designated “PAL” to depict acts performed by a PAL, and another designated “URCD” to depict acts performed by a URCD.

Step 500 calls the URCD to create a bandwidth group. An example of how this can be done is provided above. Step 502 receives the call from the PAL to create a bandwidth group and step 504 creates a bandwidth group. Step 506 then returns a bandwidth group handle to the PAL.

Step 508 receives the bandwidth group handle and step 510 uses the bandwidth group handle to make bandwidth reservations. Step 512 reserves bandwidth for the PAL using the bandwidth group handle. A handle to the reserved bandwidth is also passed back to the PAL.

Step 514 uses the bandwidth group handle (or the handle to the reserved bandwidth) to make other bandwidth-related calls. Examples of other bandwidth-related calls are given above. Step 516 receives the bandwidth related calls and step 518 takes a bandwidth-related action. Examples of bandwidth-related actions are provided above.

URC Info

In one or embodiments, various functions can be provided to handle URC information. By way of example and not limitation, these functions can include the following:

GetPhyCapablityBitmap

| VOID | | |
|---|---|---|
| GetPhyCapabilityBitmap( | | |
| in | PAL_HANDLE | PalHandle, |
| out | PPHY_CAP_BITMAP | PhyCapBitmap |
| ) | | |

### Arguments:

a. Pal: The handle to the PAL received when the PAL registered with the URCD.
b. PhyCapabilityBitmap: (Output): The Phy Capablity Bitmap as defined in the Phy Capabilities IE in the MAC spec.

GetMacCapabilityBitmap

| VOID | | |
|---|---|---|
| GetMacCapabilityBitmap( | | |
| in | PAL_HANDLE | PalHandle, |
| out | PMAC_CAP_BITMAP | MacCapBitmap |
| ) | | |

### Arguments:

a. Pal: The handle to the PAL received when the PAL registered with the URCD.
b. MacCapabilityBitmap: (Output): The MAC Capablity Bitmap as defined in the MAC Capabilities IE in the MAC spec.

GetDevAddress

| VOID | | |
|---|---|---|
| GetDevAddress( | | |
| in | PAL_HANDLE | PalHandle, |
| out | PUSHORT | Address |
| ); | | |

### Arguments:

a. Pal: The handle to the PAL received when the PAL registered with the URCD.
b. DevAddress: (Output): 16 bit device address.

GetMacAddress

| VOID | | |
|---|---|---|
| GetMacAddress( | | |
| in | PAL_HANDLE | PalHandle, |
| out | PULONGLONG | MacAddress, |
| out | PURC_PROP_STATE | MacAddrState |
| ); | | |

### Arguments:

a. Pal: The handle to the PAL received when the PAL registered with the URCD.
b. MacAddress: (Output): 48 bit MAC Address.
MacAddrState: The current state of the 48 bit MAC address being returned.

Channel Manager

In one or embodiments, various functions can be provided to handle channel management activities. By way of example and not limitation, these functions can include the following:

SetChannelBitMask

| NTSTATUS | | |
|---|---|---|
| SetChannelBitMask ( | | |
| in | PAL_HANDLE | PalHandle, |
| in | CHANNEL_BITMAP | NewMask |
| ); | | |

In one or more embodiments, by default, all of the channels that are supported by the URC are also supported by the PALs. Assume, for example, that a PAL (such as WUSB) is connected to a device that supports only certain channels. This function allows the PAL to tell the URCD to only use certain channels. This information may be useful to the URCD's Channel Manager if some other PAL requests to change to a channel not supported by the PAL. In at least some embodiments, less than all of the channels can be supported. For example, in certain regions, less than all of the channels might be supported because of regulatory issues.

### Arguments:

a. Pal: The handle to the PAL received when the PAL registered with the URCD.
b. ChannelBitMask: each bit represents a UWB channel.

### Return Value:

STATUS_SUCCESS if URCD is able to satisfy this new channel mask. If it cannot satisfy this new mask, it will return STATUS_NOT_FOUND.

StartChannel

| VOID | | |
|---|---|---|
| StartChannel( | | |
| in | PAL_HANDLE | PalHandle, |
| in_opt | PCHANNEL_BITMAP | Mask, |
| in_opt | PFN_URCD_START_CHANNEL_COMPLETION | |
| | | StartChannelCompletion, |
| in | PVOID | Context |
| ) | | |

In one or more embodiments, when a PAL wants to start a channel, it lets the URCD know by calling this function. The URCD will then call the completion routine when it has finished starting the channel.

### Arguments:

a. PalHandle: Pal Handle
b. Mask(Optional): This is a pointer to the channel bit mask indicating the channels that PAL can work with. If none has been specified—then it assumed that PAL can work with any channel. This mask can be later changed by the PAL using SetChannelBitMask function.
c. StartChannelCompletion: (Optional) If provided by the PAL, the URCD would call it to notify the PAL that it has finished processing its request.

The prototype is

| VOID | | |
|---|---|---|
| StartChannelCompletion( | | |
| in | UCHAR | Channel, |
| in_opt | PVOID | Context |

)
Channel - The channel that URC chose to beacon on.
Context - The Context that was passed in the
StartChannel Function.

d. Context: The context that is passed in the StartChannelCompletion callback.

### Return Value:

VOID

StopChannel

| VOID | | |
|---|---|---|
| StopChannel( | | |
| in | PAL_HANDLE | PalHandle, |
| in_opt | PFN_URCD_STOP_CHANNEL_COMPLETION | |
| | | StopChannelCompletion, |
| in | PVOID | Context |
| ) | | |

In one or more embodiments, when a PAL wants to stop a channel, it uses this function to let the URCD know about it. Before the PAL calls this function, it should have released and deleted all bandwidth objects. It should also have removed all the IEs and ASIEs that it might have added.

### Arguments:

a. PalHandle: Pal Handle
b. StopChannelCompletion: (Optional) If provided by the PAL, the URCD would call it to notify the PAL that it has finished processing the request. After this completion routine is called, PAL can assume that URC is not going to make any channel related calls into PAL like “ChangeChannel”,etc.
   The prototype is

VOID
StopChannelCompletion(
in_opt PVOID Context
)
Context - The Context that was passed in the
StopChannel Function.

c. Context: The context that is passed in the StopChannelCompletion callback.

### Return Value:

VOID

ScanAllChannels

| VOID | | |
|---|---|---|
| ScanAllChannels( | | |
| in | PAL_HANDLE | PalHandle, |
| in | BOOLEAN | Aggressive |
| ) | | |

This command starts a Scan for all channels.

### Arguments:

a. Pal: The handle to the PAL received when the PAL registered with the URCD.
b. Aggressive: If this bit is not set, a scan is done while INACTIVE. If this bit is set QOS reservations are preserved, and other reservations are relinquished whereafter a SCAN_WHILE_INACTIVE is performed.

Consider now some usage notes for the channel management functions in accordance with one or more embodiments. First, a PAL should not call StartChannel more than once before calling StopChannel in between. In at least some embodiments, there should be one stop channel for a start channel. In addition, SetChannelBitMask can be called any time. If called after startchannel, then it might result in a channel change (e.g., the PAL will get a notification for that, if it has provided a ChannelChange function). Finally, before changing channels, the URC calls PrepareStopChannel (if they have provided one) to the PALS which they use to complete (through a completion routine) before the URC actually changes channels.

Having considered some example functions associated with channel management activities, consider now a few miscellaneous functions.

Miscellaneous

VendorSpecificCommand

| VOID | | |
|---|---|---|
| VendorSpecificCommand( | | |
| in | PAL_HANDLE | PalHandle, |
| in | ULONG | Length, |
| in_bcount(Length) | | |
| | PVOID | Command, |
| in | PFN_URCD_VENDOR_CMD_COM- | |
| | PLETION | |
| | | Completion, |
| in_opt | PVOID | Context |
| ); | | |

This function allows Vendor Specific commands to be issued by the PAL to the URC. Thus, this function can facilitate extensibility of the overall system.

### Arguments:

a. Length: Length in bytes of the RCCB Buffer
b. Command: Pointer to the RCCB structure defined in the WHCI Spec. The RCCB.CommandContextID should be 0; URCD would fill that value in before sending it to the hardware.
c. Context: PALs Context for passing in the Callback.
d. Callback: A callback routine implemented by the PAL of the prototype:

| | | |
|---|---|---|
| VOID | | |
| CompletionCallback( | | |
| in | NTSTATUS | Status, |
| in | PVOID | EventBlock, |
| in_opt | PVOID | Context |
| ) | | |

Status: Status returned by the software indicating whether the command was successfully sent or not

EventBlock: RCEB returned by the hardware, in response to the command

Context: Context that passed in the VendorSpecificCommand function

AcquireTKID

```
ULONG
AcquireTKID(
      in  PAL_HANDLE  PalHandle
    );
```

This generates a TKID which is unique across all PALs.

### Arguments:

### Return Value:

The generated TKID

ReleaseTKID

| | |
|---|---|
| VOID | |
| ReleaseTKID( | |
| in PAL_HANDLE | PalHandle, |
| in ULONG | Tkid |
| ); | |

This releases a TKID earlier acquired by the PAL.

### Arguments:

a. TKID: The TKID to be released.

Having considered various aspects of a URCD-PAL interface, consider now a discussion of various power management features, including various functions associated with power management.

Power Management

Power management is useful to portable computing devices, and is especially useful to portable computing devices employing Ultra-Wideband technology which can consume a lot of power.

In one or more embodiments, two approaches to power management can include “sleep mode settings” which can be used to transition a host controller from an idle state to an energy conserving sleep state, as well as to govern host behavior during the time it is sleeping. In addition to the case where the host controller goes to sleep due to idleness, it can also go to sleep as part of a system wide sleep transition. In this case, sleep mode settings can govern the host behavior in this situation. “Active mode settings” can be used to govern communications between the host controller and various external devices, thereby conserving power. Each of these is discussed under its own heading below.

Sleep Mode Settings

In one or more embodiments, a host controller can go from an idle state to a sleep state in order to conserve power. Specifically, when a host controller senses that an external WUSB device is idle, the host controller, through a PAL driver, can go into a sleep mode and then periodically look for wake-up notifications from the external WUSB device. When the PAL driver receives a wake-up notification it can wake from its sleep state (e.g., transition from a sleep state to an active state) and start the active channel. Alternately or additionally, in addition to looking for wake up notifications from previously connected devices, newly connected devices can also wake the host controller. Several functions will be described which govern a host controller's behavior, through a PAL driver, before, during, and after it enters a sleep state.

A “sleep enable” setting governs whether “sleep when idle” behavior should be turned on. Specifically, it governs whether a host controller, through a WUSB PAL driver, should transition to a sleep state after being idle for defined period of time (e.g., 30 seconds, 5 minutes, 15 minutes, etc.). Transitioning to a sleep state enables the host controller to conserve power, but delays its ability to communicate with WUSB devices and therefore creates a time delay or lag time. Accordingly, there is a tradeoff between the power saved by going to sleep and the delay associated with transitioning the host controller from a sleep state to an active state.

A “sleep timeout” setting determines how long a host controller, through a PAL driver, should wait after not having any active data transfers with a WUSB device, before transitioning to a sleep mode (e.g., 30 seconds, 5 minutes, 15 minutes, etc.). For example, consider the case of a hard drive. When the user is not copying data to or from the hard drive, there is still communication taking place between the devices to, for example, maintain an authentication link. When the copying is completed and data packets are not being sent, a decision can be made that the device is idle. Going to a sleep state after a shorter period of time, conserves more power than a longer period of time. However, as noted there is a tradeoff between the power saved by going to sleep and a time delay associated with waking the host controller.

A “remote wake poll interval” setting determines how often or frequently a host controller, through a PAL driver, should wake up to listen for “remote wake” notifications from WUSB devices (e.g., 30 seconds, 5 minutes, 15 minutes, etc.). The longer a host controller sleeps the more power it conserves. However, the longer the remote wake poll interval, the less frequently the host controller awakens, and the longer the time between remote wake notifications. Thus, there is a tradeoff between lengthening wake poll interval to conserve power and the time delay in receiving remote wake notifications.

A “remote wake active period” setting determines how long a host controller, through a PAL driver, listens for notifications from WUSB devices after being waken up. Specifically, the shorter the remote wake duration, the sooner the host controller can transition back to a power conserving sleep mode. However, by shortening the remote wake duration there is the possibility that a device is not able to send a remote wake notification (e.g., host controller is still asleep) or the WUSB device is unavailable or unable to transmit a notification (e.g., WUSB device is asleep or turned off).

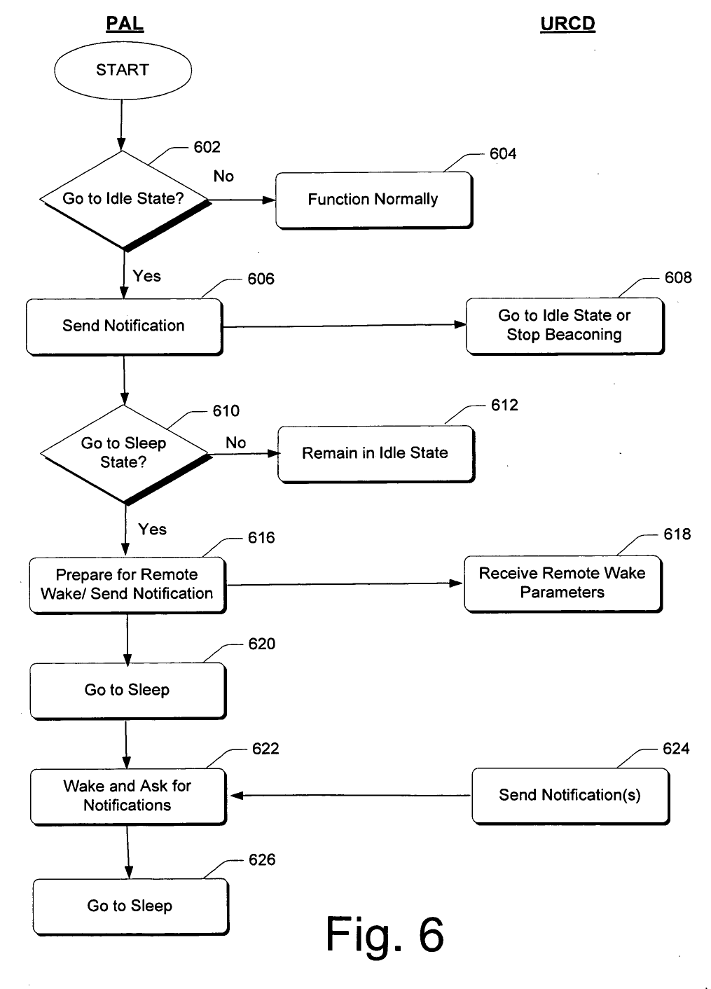

FIG. 6 is a flow diagram describing steps performed by a host controller, through its PAL driver, to manage power consumption in accordance with one or more embodiments. The steps can be implemented in connection with any suitable hardware, software, firmware or combination thereof. In at least some embodiments, the method can be implemented in software by, for example, a driver architecture such as the one described above. In the illustrated example, the flow diagram is divided into two portions—one designated “PAL” to depict acts performed by a PAL, and another designated “URCD” to depict acts performed by a URCD.

At step 602, a host controller, through a PAL driver, can determine whether to enter an idle state in order to conserve battery power. The PAL driver may be actively communicating with various WUSB devices, in which case it may decide to not enter an idle state and continue to function normally, at step 604. On the other hand, the PAL driver may not have communicated with a WUSB device for a long period of time, and therefore decide that it should enter an idle state to conserve battery power.

At step 606, once the PAL driver decides to enter an idle state and that it will not communicate with any WUSB devices, it notifies the URCD that it will be transitioning to an idle state. Based on the PAL driver's notification, the URCD can also go to an idle state or stop beaconing in order to conserve power, at step 608.

At step 610, the PAL driver can determine whether it should go to a lower power consuming state, such as, for example, a sleep state. As noted, for a PAL driver to transition to a sleep state, the “sleep enable setting” is set to “ON”, and the PAL driver cannot have received a communication from a WUSB device for at least the “sleep timeout” setting (e.g., 5 minutes). Accordingly, if the sleep enable setting is turned ON and the PAL driver has not received a communication for a predetermined period of time, the PAL driver can begin to transition to a sleep state, discussed below. Alternatively, if the sleep enable setting is turned “OFF” and/or the PAL driver has received a communication in the predetermined period of time, the PAL driver may remain in an idle state, at step 612.

At step 616, if remote wake is enabled, then the PAL driver prepares for remote wake and notifies the URCD that it is going to a sleep state. In at least some embodiments, the PAL driver informs the URCD of its remote wake polling interval and remote wake active period. In addition, the PAL driver may release all its bandwidth and request remote wake bandwidth. In an event that remote wake is not enabled, the process can proceed to step 620.

At step 618, the URCD receives the remote wake parameters from the PAL driver and prepares to enter a sleep state. In some embodiments, the URCD does not enter a sleep state on its own, but instead follows the PAL drivers' device state.

At step 620, the PAL driver transitions to a sleep state to conserve power. Specifically, the radio hardware associated with remote wake is programmed and then sent to sleep.

While in sleep mode the PAL driver can awake periodically to receive or ask for device notifications, at step 622. For example, if the PAL drivers “remote wake poll interval” setting is set for five minutes and its “remote wake active period” setting is set for fifteen seconds, the PAL wakes up every five minutes and then listens for notifications for fifteen seconds after waking up.

At step 624, the URCD may provide the PAL driver with various notifications. For example, if the URCD sends the PAL driver a PrepareForRemoteWakeBwChanges call, it is processed in the following way. First, the radio hardware is awakened and the completion routine is called for PrepareForRemoteWakeBwChanges. Next, the PAL driver sends the URCD a bandwidth allocation change notification and the associated hardware is re-programmed based on the new allocation. Bandwidth allocation change notifications and associated hardware re-programming are performed until the URCD calls NoMoreRemoteWakeBwChanges.

At step 626, after the NoMoreRemoteWakeBwChanges has been called, the PAL driver goes back to sleep. If a remote wake signal is received while the PAL driver is sleeping, it is processed in the following way. First, the signal is verified to ensure that it was generated by the associated hardware. If it was not, then the signal is ignored. If the signal was generated by the associated hardware, then the PAL first calls ResumeChannel through the URCD PAL interface to resume the URCD channel and then waits for its completion. Once the URCD has called ResumeChannelCompletion, then the associated hardware is awakened and the remote wake bandwidth is released. Normal functioning can now resume.

Since it is possible that the PAL driver might temporarily wake up its hardware to process bandwidth changes, it is undesirable for the PAL driver to wake up for each of these notifications. To overcome this problem, in at least some embodiments, the URCD provides two additional notifications, which the PAL driver provides during initial registration: PrepareForRemoteWakeBwChanges and NoMoreRemoteWakeBwChanges. When the PAL driver receives the PrepareForRemoteWakeBwChanges notification, it should do whatever is done to process the bandwidth changes (e.g., wake up its hardware) before calling the completion routine. When the PAL driver receives the NoMoreRemoteWakeBwChanges, it can safely go back to the previous state.

In at least some embodiments, a PAL driver will also consider synchronization issues that might arise because of the various independent events overlapping with each other, e.g., the URCD giving bandwidth allocation change notifications and the PAL driver getting a wake signal (either from the hardware or from software). In order to assist PAL drivers, the URCD can serialize the processing of Remote wake BW change notifications and ResumeChannel calls so that if a PAL driver calls ResumeChannel while a Bandwidth Allocation Change is in progress, the URCD will not call the completion routine for the ResumeChannel call until the current BW allocation change process completes i.e. it receives a CompletionCallback for NoMoreRemoteWakeBwChanges from the PAL driver.

Consider now some various functions associated with power management activities.

SleepChannel

| VOID | | |
|---|---|---|
| SleepChannel( | | |
| in | PAL_HANDLE | PalHandle, |
| in_opt | PFN_URCD_SLEEP_CHANNEL_COMPLETION | |
| | | SleepChannelCompletion, |
| in | PVOID | Context |
| ) | | |

When the PAL driver has gone to sleep, it lets URCD know by calling this function.

### Arguments:

a. PalHandle: Pal Handle
b. SleepChannelCompletion: (Optional) If provided by the PAL, the URCD would call it to notify the PAL that it has finished processing its request.

The prototype is

VOID
SleepChannelCompletion(
in_opt PVOID Context
)
Context - The Context that was passed in the
SleepChannel Function.

c. Context: The context that is passed in the SleepChannelCompletion callback.

### Return Value:

VOID

ResumeChannel

| VOID | | |
|---|---|---|
| ResumeChannel( | | |
| in | PAL_HANDLE | PalHandle, |
| in_opt | PFN_URCD_RESUME_CHANNEL_COM- | |
| | PLETION | |
| | | ResumeChannelCompletion, |
| in | PVOID | Context |
| ) | | |

When a PAL driver wants to resume from a channel, it uses this function to make sure the URC is awake.

### Arguments:

a. PalHandle: Pal Handle
b. ResumeChannelCompletion: (Optional) If provided by the PAL, the URCD would call it to notify the PAL that it has finished waking up URC

The prototype is

VOID
ResumeChannelCompletion(
in_opt PVOID Context
)
Context - The Context that was passed in the
ResumeChannel Function.

c. Context: The context that is passed in the ResumeChannelCompletion callback.

### Return Value:

VOID

RemoteWakeBWReserve

NTSTATUS

| in | BW_HANDLE | BWHandle, |
|---|---|---|
| in | UWB_BW_INTERVAL | Interval, |
| in | USHORT Time, | |
| in_opt | PUWB_MAS_MAP | DeviceAvailability, |
| in | ULONG Flags, | |
| in | PFN_URCD_CALLBACK_BW_RESERVE | |
| | | CallbackOnReserve, |
| in_opt | PVOID | ReserveContext, |
| in_opt | PFN_URCD_CALLBACK_BW_ALLOCATION_CHANGE | |
| | | CallbackOnChange, |
| in_opt | PVOID | ChangeContext |
| ); | | |

A PAL driver uses this function to reserve bandwidth required for supporting remote wake. The meaning of the parameters and return value is the same as the CriticalBWReserve function. When the PAL driver gets CallbackOnChange for such bandwidth, the PAL driver might have to wake itself, deal with the change and then go back to sleep. The PAL driver should call the completion routine for the CallBackOnChange routine when all these steps have been completed.

RemoteWakeSetParameters

NTSTATUS
RemoteWakeSetParameters(

| | | |
|---|---|---|
| in | PAL_HANDLE | PalHandle, |
| in_out | PULONG | RemoteWakePollInterval, |
| in_out | PULONG | RemoteWakePollActivePeriod |
| ) | | |

A PAL driver uses this function to tell the URCD about its remote wake requirements before it goes to sleep so that when the URCD sends the URC to sleep, it can make sure that URC wakes up periodically and keep the channel awake as per the PAL's requirements.

### Arguments:

a. PalHandle: Pal handle.
b. RemoteWakePollInterval: This is the period in units of superframes after which PAL regularly wakes up and looks for wake notifications. PAL gives this parameter as input but URC might return a different value which will be less than equal to the original parameter specified by the PAL.
c. RemoteWakePollActivePeriod—This is the period, in units of superframes, for which PAL needs to be awake after each RemoteWakePollInterval. PAL gives this parameter as input but URC might return a different value which will be less than equal to the original parameter specified by the PAL.

### Return Value:

STATUS—URCD returns STATUS_INVALID_PARAMETER if it cannot satisfy PAL's requirements, otherwise returns STATUS_SUCCESS.

Active Mode Settings

Sleep mode settings generally govern a host controller, through a PAL driver, as it transitions from an idle state to an energy conserving sleep state. In contrast, active mode settings generally govern communications between a host controller and various devices, such as WUSB devices, thereby conserving power.

A host controller, through one or more PAL drivers, generally advertises itself to WUSB devices by sending host info information elements. A host controller typically includes information elements (IE's) in at least three MMC's per super frame. However, host controllers typically include IEs in more than three MMC's per super frame to minimize the delay in connecting new WUSB devices. With respect to the three MMC's per super frame, consider the following. At the URC level, time is divided into intervals of 65 msecs—whose intervals are referred to as superframes. Each superframe is then divided into 256 MASes. URC allocates Banwidth to different PALs at the MAS level. Within the MASes allocated, WUSB PAL starts its own channel in form of a continuous sequence of linked control packets called MMCs (Micro-scheduled Management Commands). Each of these MMCs can contain one or more IEs (information elements) and many of the IEs are sent in multiple MMCs in each superframe. As per WUSB spec, a host includes the host IE in at least three MMCs in every superframe.

A “host info information elements frequency” setting generally defines the frequency that IEs are transmitted in MMC's. By reducing the frequency of IEs in the MMC's, the host controller, through a PAL driver, transmits less data and therefore consumes less power. However, by reducing the frequency of IEs, a WUSB device may have to wait up to a super frame (e.g., 65 milliseconds) before receiving the host controller's address and starts connecting to the host controller. Thus, there is a connection delay or time lag associated with reducing the frequency of IE's sent to WUSB devices.

A host controller, through a PAL driver, can schedule device notification time slots (DNTS slots) so that WUSB devices can send it notifications (e.g.,DN_CONNECT, DN_EPRdy, DN_REMOTEWAKE, etc). However, the WUSB specification (Wireless Universal Serial Bus Specification, Revision 1.0 (section 4.9) does not specify a minimum frequency of DNTS slots. Accordingly, a PAL driver can reduce the frequency of DNTS slots and the data that it receives. Since the PAL driver receives and responds to less data, its power consumption is generally reduced. However, by reducing DNTS slot frequency, the time between WUSB notifications is increased and the WUSB devices have fewer opportunities to send notifications. Thus, decreasing the DNTS slot frequency can create delays which can impact communications between the PAL driver and WUSB devices.

In addition, a host controller, through a PAL driver, can specify the the number of DNTS slots per period that it uses to send notifications to WUSB devices. More DNTS slots per period provide PAL drivers with more opportunity to listen for notifications and WUSB devices with more opportunity to send notifications, thus ensuring that the WUSB notifications are sent and received. In contrast, fewer DNTS slots per period reduce the PAL drivers listening opportunity and the WUSB devices notification opportunity. By reducing listening opportunity, the host controller can transition more quickly to a sleep state and reduce is power consumption. However, reducing DNTS slots per period to conserve power can impact communications between the PAL drivers and WUSB devices.

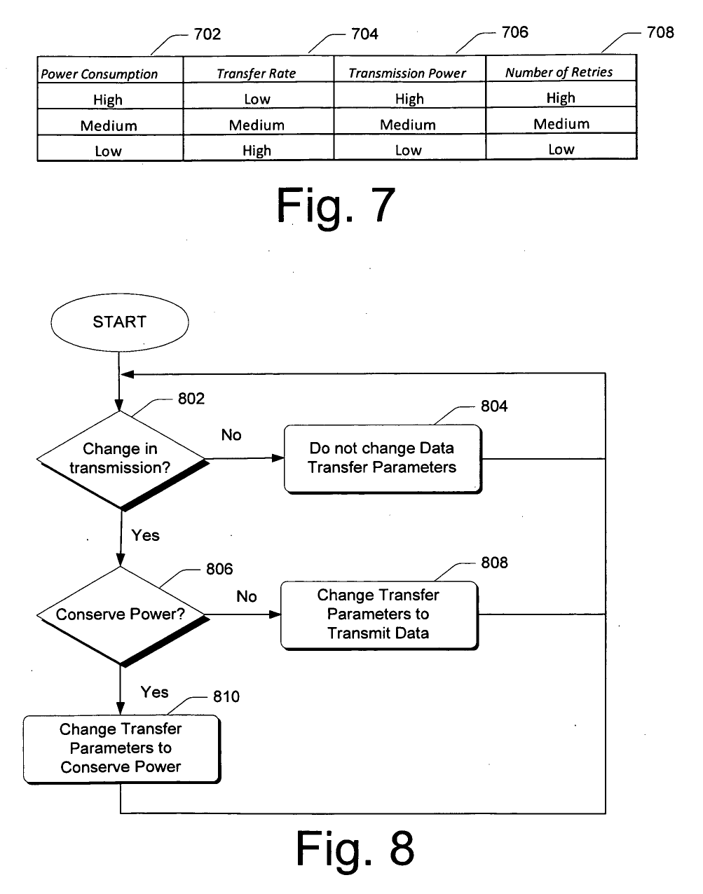

In addition to efficiently using DNTS slot parameters to reduce energy consumption, a host controller, through a PAL driver, can manage its data transfer parameters to reduce energy consumption. FIG. 7 illustrates a table of data transfer parameters in accordance with one or more embodiments.

Power consumption settings 702 describe three different power consumption settings—high, medium and low. Transfer rate 704 generally refers to a data transfer rate or bit rate that a host controller uses to communicate with a WUSB device. Generally, lower data rates provide better sensitivity and thus greater range. However, higher transfer rates generally allow communications to be performed more quickly, in less time, and potentially use less power. For example, a low data transfer rate might be 53.3 M bit/second, a medium data transfer rate might be 200 M bit/second, and a high data transfer rate might be 12 M bit/second. Data transmitted at the low transfer rate of 480 M bit/second would generally takes 4 times longer to transmit than data transmitted at the medium transfer rate of 200 M bit/second, and therefore can consume more power.

Transmission power 706 generally refers to the amount of radio frequency (RF) energy that is transmitted by a RF source, such as radio hardware 112 of FIG. 1. Transmission power is generally measured in Watts, milli-watts, or decibels (dbm). Since host controllers and WUSB devices may be battery powered, the lower the transmission power the better. However, if transmission power is too low, WUSB devices may not receive the host controller's transmissions. Thus, a host controller should transmit at the lowest practical transmission power setting to conserve power.

Number of retries 708 generally refers to the number of times a host controller retransmits a message to a WUSB device when the WUSB device fails to receive and/or respond to the message. The number of retries can be any suitable number and are generally designated here as “low”, “medium” and “high”. Since retransmitting a message consumes power and prevents the host controller from going to an idle or sleep state, it can significantly increase energy consumption. Accordingly, the number of retries 708 or rebroadcasts should, in at least some instances, be reduced to conserve power. The number of retries may be attempted before adjusting other settings such as Transfer Rate or Transmission Power settings.

It should be appreciated that a host controller, through a PAL driver, can select any combination of parameters (e.g., transfer rate 704, transmission power 706, and number of retries 708) to reduce energy consumption. Moreover, a host controller may start transmitting at a first set of transfer parameters and then change to a second set of transfer parameters based on a change in transmission conditions (e.g., transmission distance, obstacles in transmission path, weather conditions, etc.), a change in WUSB devices (e.g., computer mouse, keyboard, storage device, printer, etc.), as well as other factors that could affect RF communications. For example, a host controller could be transmitting at a low power consumption level to conserve battery power, and then switch to a medium or high power consumption level as the transmission distance between it and the WUSB device increases. Alternatively, the host controller could be operating at a medium or high power consumption level and then switch to a low power consumption level to communicate with a WUSB device that is closely adjacent.

FIG. 8 is a flow diagram describing steps in a power management method in accordance with one or more embodiments. Specifically, FIG. 8 illustrates how a host controller, through a PAL driver, can manage its data transfer rate 704, transmission power 706, and the number of retries 708, to manage its power consumption.

At step 802, the host controller monitors for changes in transmission conditions. For example, the transmission conditions could change while the host controller is communicating with a WUSB device (e.g., transmission distance increases, obstacle blocks transmission path, etc.) and/or the host controller fails to receive a response or notification from the WUSB device.

At step 804, if the host controller does not sense a change in transmission conditions, the host controller may maintain its current data transfer parameters. Alternatively, if the host controller has detected a change in transmission conditions, the host controller can determine whether it should modulate or change its data transfer parameters to conserve power or improve data transmission, at step 806.

In some situations, the host controller can change its transfer parameters to make it more likely that its communications are received by a WUSB device, at step 808. For example, if the host controller, through a PAL driver, is transmitting a print job to a WUSB printer and the host controller is suddenly moved to an adjacent room, the host controller might sense the change in transmission conditions, and increase its transmission power, reduce its data transfer rate, and/or increase the number of retires to ensure that the WUSB printer receives the print job. Alternatively, if the host controller is operating in a low power consumption mode, it could step-up to a medium or high power consumption mode to ensure that the WUSB printer receives the print job.

In other situations, if the host controller is in a “power save mode” or its battery power is getting low, it might change its transfer parameters to conserve battery power, at step 810. For example, if a client device is placed next to the host controller, the host controller might reduce transmission power, increase its data transfer rate, and/or reduce the number of retries to conserve battery power. Alternatively, the host controller might go from a high or medium power consumption level to a low power consumption level to conserve battery power. In other embodiments, the conserve power decision at step 806 can be performed first, followed by the change in transmission decision at step 802.

Having described how a host controller, through a PAL driver, can manage its data transmission parameters to manage communication or conserve battery power, consider now how bandwidth may be managed to conserve energy.

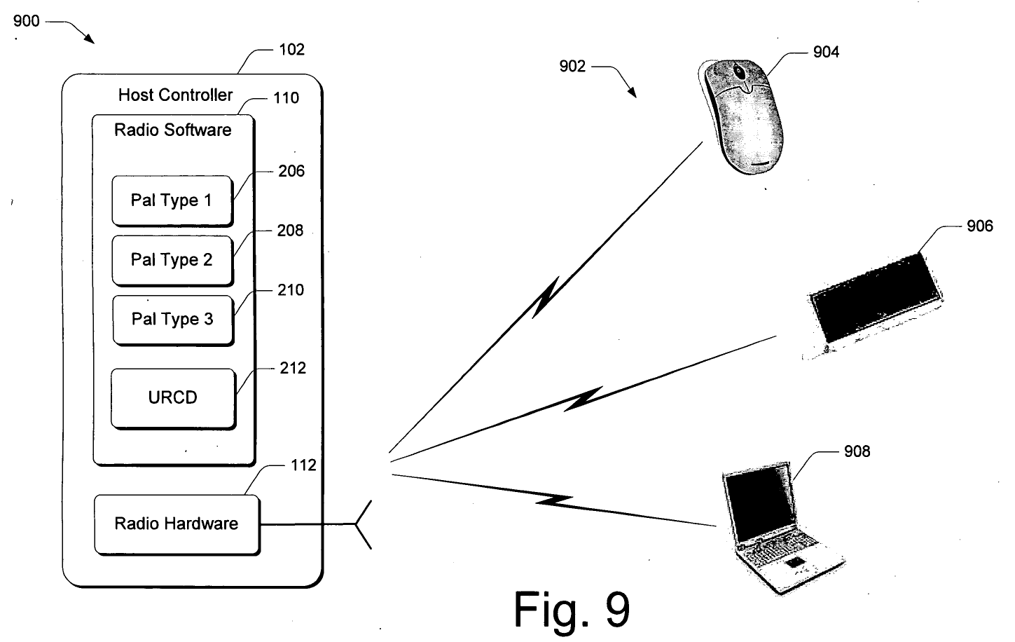

FIG. 9 illustrates an operating environment 900 in accordance with one or more embodiments. FIG. 9 is a combination of FIGS. 1 and 2 and hence uses at least some designators from each.

In this example, the operating environment 900 may include a wireless host controller 102 and various external devices shown generally at 902. External devices include, by way of example and not limitation, a mouse 904, a flash drive 906, and a laptop computer 908. The external devices 902 communicate, in at least some embodiments, with host controller 102 via a Universal Serial Bus (USB) which employs Ultra-wideband technology. The host controller 102 may include radio software 110 and radio hardware 112. The radio software includes one or more protocol adaption layer (PAL) drivers 206, 208, and 210 which are associated with various bus technologies such as, for example and not limitation, WUSB, WLP, Bluetooth, and/or other bus technologies. The radio software 110 also includes an Ultra-wideband radio control driver (URCD) 212 which generally manages the radio hardware 112 (e.g., radio transceiver). In general, the PAL drivers 206, 208, 210, and URCD 212 communicate with the external devices 902 using one or more communications protocols. For example, PAL Type 1 206 may communicate with wireless mouse 904 using a first communications protocol, PAL Type 2 208 may communicate with a flash drive 906 using a second communications protocol, and PAL Type 3 210 may communicate with a laptop computer 908 using a third communications protocol. Accordingly, each of the PAL drivers can share allocated bandwidth with the other PAL drivers using, for example, time division multiplexing.

In general, time division multiplexing enables two or more signals or bit streams to be transmitted as sub-channels in one communications channel. In UWB, each sub-channel can reserve any set of slots. After the data associated with last sub-channel has been transmitted the cycle generally starts all over again with a second block of data from a sub-channel.

Critical bandwidth, as pointed out above, is generally the amount of bandwidth that a PAL driver needs to perform its basic functions (e.g., signaling, authentication, transmit data, and error detection, etc.). For example, if a web cam were streaming images, the critical bandwidth would be that to ensure that the stream does not experience a glitch.

The URCD 212 and/or a bandwidth manager residing in radio software 110, can vary the bandwidth limit (i.e., the amount of bandwidth above the critical bandwidth) provided to each PAL driver to conserve power. Specifically, the URCD 212 can allocate less bandwidth to each PAL driver, thus increasing the idle time of the radio hardware 112. In one or more embodiments, bandwidth is distributed to the PALs in terms of units of time (referred to as MASes) within each superframe. The amount of data that can be transferred depends upon the individual PAL and device characteristics. For example, if a PAL driver has a critical bandwidth of a first number of units of time, there is a single PAL driver communicating with three different WUSB devices, and there is a total available bandwidth of a second larger number of units of time, the URCD 212 may conserve power by allocating each PAL driver a subset of available time units, and then idle the radio hardware 112 for the remaining time units. Alternatively, the URCD 212 can maximize communications by allocating each PAL driver an equal share of the second larger number of time units and then operate the radio hardware 112 for the entire transmission time.

It should be appreciated that the URCD 212 could also assign bandwidth, in time units, based on the type of WUSB device that it is communicating with. For example, if the WUSB device is a wireless mouse 904 or keyboard, the URCD 212 may provide the wireless mouse 904 with a larger bandwidth allocation in time units than a flash memory device 906. In summary, the URCD 212 and/or bandwidth manager may limit the bandwidth provided to each PAL driver by varying each PAL driver's bandwidth limit setting, thereby conserving power.

In one or more embodiments, the URCD 212 and/or a bandwidth manager can employ bandwidth defragmentation to reduce data transfer interruptions and conserve power. Defragmentation refers to defragmenting allocated MASes within a superframe. The URCD can re-adjust the total allocation of MASes and can thus vary how aggressively it attempts to defragment its channel time allocations to try to increase the duration that the radio remains idle for a continuous period of time within a superframe. This can allow for hardware level power optimizations which can save power. This may, however, potentially cause a small disruption in the end-user's experience as bandwidth for devices is potentially taken away and then re-assigned.

To comply with the Media Access Control (MAC) specification (Distributed Medium Access Control (MAC) for Wireless Networks (Approved Draft 1.2, Mar. 4, 2008)), the URCD 212 may periodically rebalance or reallocate bandwidth to ensure that it is allocated efficiently. With respect to rebalancing bandwidth, consider the following. In at least some embodiments, WiMedia provides guidelines (which are aimed at smoothing the co-existence of multiple hosts) on how a particular host should allocate MASes within a superframe. This refers to the total allocation done by a host on behalf of all the Pals. Initially when URCD allocates bandwidth, it follows those guidelines. But as the individual bandwidth allocations change, the overall allocation might be such that it is no longer following WiMedia guidelines. So, good driver implementations periodically look at their overall allocation and adjust it so that it is compliant with WiMedia policy. Since these WiMedia guidelines are not aimed at power consumption, it actually cost some power do this rebalancing operation, But since WiMedia does not give a guideline on how frequently that operation should occur, the operation frequency can be adjusted as per the power goals. With respect to varying the bandwidth limit, consider the following. The URCD bandwidth manager can choose to limit the amount of non-critical bandwidth to be assigned to PALs so that the radio can remain idle for a longer amount of time and power can be saved at the expense of performance.

For example, if a host controller communicates with three external devices over three sub-channels, it may rebalance the bandwidth allocated to each device. Thus, the bandwidth rebalance sensitivity setting determines how frequently the URCD rebalances or reallocates bandwidth among the external devices it communicates with to reduce energy consumption. Rebalancing in the manner discussed above can provide a good balance between letting the system sit idle by not rebalancing very often, thus saving power and adjusting reservation more aggressively, resulting in a better responsiveness to changing conditions.

When establishing communications with an external device, the URCD may select a channel with the least amount of communication traffic to increase available bandwidth. However, once the URCD has selected a channel and established communications, the channel can become congested (e.g., other host controllers and/or external devices use the sub-channel). In response to the channel becoming congested, the URCD may scan the other channels to find an unused or underutilized channel to use. By switching to a less congested channel the URCD and external devices can communicate more efficiently and effectively. Accordingly, a channel selection sensitivity value can define how often channel scanning is performed. With a higher value, more scanning can be performed albeit at a high power consumption. An advantage of a higher value is the potential advantage in the amount of bandwidth available because a better channel can be chosen more quickly.

Having described example embodiments in which sleep mode and active mode settings can be used to conserve power. The discussion now shifts to an example computing device capable of implementing the described embodiments.

Example System

FIG. 10 illustrates an example computing device 1000 that can implement the various embodiments described above. Computing device 1000 can be, for example, computing device 102 of FIG. 1 or any other suitable computing device.

Computing device 1000 includes one or more processors or processing units 1002, one or more memory and/or storage components 1004, one or more input/output (I/O) devices 1006, and a bus 1008 that allows the various components and devices to communicate with one another. Bus 1008 represents one or more of any of several types of bus structures, including a memory bus or memory controller, a peripheral bus, an accelerated graphics port, and a processor or local bus using any of a variety of bus architectures. Bus 1008 can include wired and/or wireless buses.

Memory/storage component 1004 represents one or more computer storage media. Component 1004 can include volatile media (such as random access memory (RAM)) and/or nonvolatile media (such as read only memory (ROM), Flash memory, optical disks, magnetic disks, and so forth). Component 1004 can include fixed media (e.g., RAM, ROM, a fixed hard drive, etc.) as well as removable media (e.g., a Flash memory drive, a removable hard drive, an optical disk, and so forth).

One or more input/output devices 1006 allow a user to enter commands and information to computing device 1000, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

Various embodiments enable a host controller, through its Protocol Adaption Layer (PAL) driver, to manage its power consumption by employing “sleep mode” and “active mode” power settings. In some embodiments, the PAL driver may employ sleep mode settings to transition the host controller from an idle state to an energy conserving sleep state. In further embodiments, the PAL driver may employ active mode settings to govern communications between the host controller and various external devices, thereby conserving power.

Although the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter

What is claimed is:

1. Computer readable storage media comprising computer executable instructions which, when executed by a processor, provides a software architecture comprising:
at least one protocol adaption layer (PAL) driver;
an ultra-wideband radio control driver (URCD); and
an interface configured to enable two-way communication between the at least one PAL driver and the URCD, wherein the interface comprises:
functions to enable the at least one PAL driver to implement one or more power settings associated with the at least one PAL driver and/or enable the URCD to implement one or more power settings associated with the URCD in response to one or more events.

2. Computer readable storage media as recited in claim 1, wherein the one or more events comprise at least one of a user action or a system wide event.

3. Computer readable storage media as recited in claim 1, wherein the at least one PAL driver employs Wireless Universal Serial Bus (WUSB) technology.

4. Computer readable storage media as recited in claim 1, wherein the one or more power settings comprise sleep mode settings and/or active mode settings.

5. Computer readable storage media as recited in claim 4, wherein the sleep mode settings comprise one or more of:
a sleep enable setting,
a sleep timeout setting,
a remote wake poll interval setting, and/or
a remote wake activity period setting.

6. Computer readable storage media as recited in claim 4, wherein the active mode settings comprise one or more of:
a host info information elements frequency setting,
a device notification time slot (DNTS) frequency setting,
a device notification time slot (DNTS) width setting,
a data transfer parameters setting,
a bandwidth limit setting,
a bandwidth defragmentation setting,
a bandwidth rebalance sensitivity setting, and/or
a channel selection sensitivity setting.

7. Computer readable storage media as recited in claim 1, wherein the one or more power settings comprise active mode settings comprising one or more data transfer parameters settings, the data transfer parameters settings comprising one or more of a data transfer rate, transmission power, and/or a number of retries.

8. Computer readable storage media as recited in claim 1, wherein the one or more power settings comprise active mode settings comprising one or more data transfer parameters settings, and wherein the data transfer parameters settings are optimized based in part on a type of external device

9. Computer readable storage media comprising computer executable instructions which, when executed by a processor, provides an application program interface comprising:
at least one function to enable communication between at least one protocol adaption layer (PAL) driver and an ultra-wideband radio control driver (URCD), wherein the at least one function enables the at least one PAL driver and/or URCD to change individual power settings in response to a sensed condition.

10. Computer readable storage media as recited in claim 9, wherein the sensed condition pertains to one or more of a condition associated with a user input or a condition associated with a system wide event.

11. Computer readable storage media as recited in claim 9, wherein the sensed condition comprises one or more user inputs, low battery power, a change in RF transmission conditions, a change from AC to DC power or vice versa, and/or a change of external devices.

12. Computer readable storage media as recited in claim 9, wherein the power settings comprise sleep mode settings and/or active mode settings.

13. Computer readable storage media as recited in claim 12, wherein the sleep mode settings comprise one or more of:
a sleep enable setting,
a sleep timeout setting,
a remote wake poll interval setting, and/or
a remote wake activity period setting.

14. Computer readable storage media as recited in claim 12, wherein the active mode settings comprise one or more of:
a host info information elements frequency setting,
a device notification time slot (DNTS) frequency setting,
a device notification time slot (DNTS) width setting,
a data transfer parameters setting,
a bandwidth limit setting,
a bandwidth defragmentation setting,
a bandwidth rebalance sensitivity setting, and/or
a channel selection sensitivity setting.

15. A method comprising:
sensing a condition,
changing one or more individual power settings associated with at least one protocol adaption layer (PAL) driver and/or an ultra-wideband radio control driver (URCD), wherein the at least one PAL driver and/or URCD changes the one or more power settings in response to the sensed condition; and
transmitting data using the changed power settings.

16. A method as recited in claim 15, wherein the PAL driver is Wireless Universal Serial Bus PAL driver.

17. A method as recited in claim 15, wherein the sensed condition comprises one or more user inputs, low battery power, a change in RF transmission conditions, a change from AC to DC power or vice versa, and/or a change of external devices.

18. A method as recited in claim 15, wherein the one or more individual power settings comprise one or more sleep mode settings and/or one or more active mode settings.

19. A method as recited in claim 18, wherein the sleep mode settings comprise one or more of:
a sleep enable setting,
a sleep timeout setting,
a remote wake poll interval setting, and/or
a remote wake activity period setting.

20. A method as recited in claim 18, wherein the active mode settings comprise one or more of:
a host info information elements frequency setting,
a device notification time slot (DNTS) frequency setting,
a device notification time slot (DNTS) width setting,
a data transfer parameters setting,
a bandwidth limit setting,
a bandwidth defragmentation setting,
a bandwidth rebalance sensitivity setting, and/or
a channel selection sensitivity setting.
